(19) United States
(12) Patent Application Publication
(10) Pub. No.: US 2005/0025889 A1
(43) Pub. Date: Feb. 3, 2005

(54) Coating method and coating line

(75) Inventor: Kazuo Yago, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/869,051

(22) Filed: Jun. 17, 2004

(30) Foreign Application Priority Data
Jun. 18, 2003 (JP) 2003-172919

(51) Int. Cl. B05D 3/02

(52) U.S. Cl. 427/314; 427/356

(57) ABSTRACT

A web is fed from a feeder to a leveling treatment chamber. The web is heated with heating rollers in the temperature range of 50 to 125° C. provided in the heating zone of the leveling treatment chamber. In this heating operation, warm air in the temperature range of 30 to 125° C. is blown from a warm air fan into the heating zone. Then the web is fed to the cooling zone of the leveling treatment chamber and cooled with cooling rollers. The temperature of the cooing rollers is controlled with a temperature controller while measuring the surface temperature of the web with a temperature sensor placed downstream relative to the leveling treatment chamber. Controlling the temperature of the web before the coating operation to 25 to 45° C. enables the surface of the web to be leveled, thereby enabling an excellent coating film to be formed with a coating apparatus.

### BACKGROUND OF THE INVENTION

1. Field of the Invention

This invention relates to a coating method and a coating line for coating a continuously running belt-like substrate (hereinafter referred to as web) with various kinds of liquid compositions in the production of thermal-developable light-sensitive materials, heat or thermal sensitive materials and the like.

2. Description of the Related Art

In coating a web with various kinds of liquid compositions (hereinafter referred to as coating solution), if the surface of the web is not in the uniform state, the surface cannot be uniformly coated. For example, when the surface of a web is statically charged and the amount of charge has a distribution, the ease of wetting the web of the coating solutions differs from position to position on the web surface, whereby the position at which the coating solution and the web come in contact with each other (hereinafter referred to as dynamic contact line) varies up and down with the variation in the amount of charge. The positional variation of the dynamic contact line will be described with reference to FIG. 4. As shown in FIG. 4, when a web 71 is coated with a coating solution 72 from a coating die 70, a dynamic contact line 73 moves to change the amount of the coating solution flowed in and that of the coating solution flowed out at bead portion 72a, thereby causing coating non-uniformity. To avoid such a problem, a method for retarding the occurrence of coating non-uniformity has been adopted in which the surface of the web to be coated with a coating solution is moistened to reduce its surface resistance so that its non-uniformity in charge is leveled off, as disclosed in Japanese Patent Application Publication No. 4-244263. The method can eliminates the cause of the coating non-uniformity when the basic cause of the coating non-uniformity is non-uniformity in electrification of the web and is very effective as surface preparation before coating.

### SUMMARY OF THE INVENTION

One big problem with the method, however, is that it is ineffective when the basic cause of the coating non-uniformity is not non-uniformity in electrification, but irregularities of the web. For example, a web 80 is a roll, which is referred to as bulk roll 82, wound around a core tube 81 as shown in FIG. 5 and is usually fed and conveyed. More than one bulk rolls 82 are connected to each other with a joining tape and continuously coated with a coating solution. However, the portion immediately in front of the joint of 5 to 10 turns of the web 80, on the basis of the core tube 81 turn cycle, undergo plastic deformation (hereinafter referred to as repeated deformation in cut edge 83), as shown in FIG. 6, because of the effect of the non-level end surface of the web and the strong contact pressure near the core tube 81. In the repeated deformation in cut edge 83 caused by the plastic deformation of the web 80 near the core tube 81, the irregularities are large, compared with those caused by the plastic deformation of the web in other parts of the core tube 81, because of the strong winding pressure from the periphery of the bulk roll 82 (refer to FIG. 5). The bulk roll 82 of FIG. 6B shows only part of the repeated deformation in cut edge 83. Thus, as shown in FIG. 7, near the portion where a web 90 and a web 91 are joined by a joining tape 92, the surfaces of the webs 90 and 91 are highly disturbed because of the non-levelness caused by the joining tape 92 and the irregularities caused by the repeated deformation in cut edge 93. These irregularities, though they are microscopic themselves, become a very large disturbance when a coating solution is applied thereto and give rise to a problem of being apt to cause coating non-uniformity at the portions of the repeated deformation in cut edge.

Accordingly, the object of this invention is to provide a coating method and a coating line which eliminate the occurrence of coating non-uniformity even under the conditions where irregularities exist on the surface of the web.

One aspect of this invention is to restore a web having undergone plastic deformation, including repeated deformation in cut edge, to its original state by heating and draw the web before the coating operation, and besides, to control the coating non-uniformity by optimizing the back surface depressurization at the time of coating, the distance between a die and a lip, and the temperature of a coating solution.

The coating method of this invention is a coating method for coating a continuously running web with a coating solution from a die in the process of producing a thermal-developable light-sensitive material, wherein the surface of the web is subjected to leveling treatment before the coating operation. Preferably the leveling treatment includes: a heating step of heating the web; and a cooling step of cooling the same.

Preferably the heating step includes at least either a step of heating the web with a heating roller in the temperature range of 50 to 125° C. or a step of blowing air in the temperature range of 30 to 125° C. on the web. Preferably the cooling step is a step of cooling the web with a cooling roller to 25 to 45° C. Still preferably the cooling step is a step of blowing air whose temperature is lower than that of the web.

Preferably the draw rate when the heating roller draws the web is in the range of +0.2 to +2.0%. The term “draw rate” herein used means the ratio of the unit length (L1) of the web when it is running to the unit length (L0) of the same when it stands still (=(L1-L0)/L0)×100(%)).

After the cooling step and before the coating step of coating the web with the coating solution, it is preferable to measure the web temperature before the coating operation and control the temperature of the web in the heating and cooling steps based on the measured web temperature before the coating operation. In this case, the web temperature before the coating operation is preferably in the range of 25 to 45° C. and most preferably in the range of 30 to 40° C.

Preferably more than one heating roller is provided and the temperatures of downstream heating rollers are set higher than those of upstream heating rollers. More preferably the difference in temperature between the most upstream heating roller and the most downstream heating roller is 10 to 50° C.

Preferably more than one cooling roller is provided and the temperature of downstream cooling rollers is set lower than that of upstream cooling rollers. More preferably the difference in temperature between the most upstream cooling roller and the most downstream cooling roller is 10 to 50° C.

In the heating step, at least one of the heating rollers and a conveying roller for allowing the web to run is used and preferably the lapping angle of the web passed around the roller is in the range of 30 to 240 degrees, more preferably in the range of 90 to 200 degrees and most preferably in the range of 160 to 200 degrees.

Preferably, the coating method is a slide bead coating method in which the coating solution fed through the die is applied to continuously running web through bead forming, wherein a coating device that allows the coating rate of the coating solution to be U (m/s) is provided and distance d (m) is provided between the lip of the die and the web, so that the effective viscosity of the coating solution adjacent to the web becomes 15 to 30 mpa·s, and the specified shear rate is U/d.

Preferably the reduced pressure of the back surface of the bead is set to fall in the range of 300 to 1000 Pa. Preferably the distance d between the lip of the die and the web is set to fall in the range of 140 to 300 μm. Still preferably the temperature of the coating solution is set to fall in the range of 34 to 42° C. More preferably the reduced pressure of the back surface of the bead, the distance d between the lip of the die and the web and the temperature of the coating solution are set to fall in the range of 300 to 1000 Pa, in the range of 140 to 300 μm and in the range of 34 to 42° C., respectively, at the same time.

The coating line of this invention is a coating line that includes a coating apparatus for coating a continuously running web with a coating solution from a die, wherein the line further includes an apparatus, which levels the surface of the web, upstream of the coating apparatus.

Preferably the surface leveling apparatus is made up of a heating portion for heating the web and a cooling portion for cooling the same. Preferably the heating portion includes either a heating roller in the temperature range of 50 to 125° C. or an air blowing device that blows air in the temperature range of 30 to 125° C. Still preferably the cooling portion includes a cooling roller in the temperature range of 20 to 50° C. Still preferably the coating line further includes a web running device that allows the draw rate when the heating roller draws the web to fall in the range of +0.2 to +2.0%.

Preferably the coating line further includes: a measuring device, which measures the web temperature before the coating operation, between the cooling portion and the coating apparatus; and a controlling device, which controls the temperatures of the web in the heating portion and in the cooling portion based on the temperature measured before the coating operation. More preferably the controlling device is a device that controls the web temperature before the coating operation so that it falls in the range of 25 to 45° C. and most preferably in the range of 30 to 40° C.

Preferably, the heating portion includes more than one heating roller and the temperatures of downstream heating rollers are set higher than those of upstream heating rollers. Preferably, the cooling portion includes more than one cooling roller and the temperatures of downstream cooling rollers are set lower than those of upstream cooling rollers. The heating portion includes at least either the heating roller or a conveying roller that allows the web to run and preferably the roller included in the heating portion is arranged so that the lapping angle of the web passed around the roller falls in the range of 30 to 240 degrees. The lapping angle is more preferably 90 to 200 degrees and most preferably 160 to 200 degrees.

Preferably the coating apparatus is a slide bead coating apparatus that feeds the coating solution from the die in such a manner as to form a bead so as to coat a continuously running web with the coating solution, wherein the coating apparatus includes a coating device that coats the web with the coating solution at a coating rate of U (n/s) and the distance of the lip of the die and the web is d (m), so that the effective viscosity of the coating solution adjacent to the web is 15 to 30 mpa·s at a specified shear rate, the specified shear rate being U/d.

Preferably the reduced pressure of the back surface of the bead is set to fall in the range of 300 to 1000 Pa. Preferably the distance d between the lip of the die and the web is set to fall in the range of 140 to 300 μm. Still preferably the temperature of the coating solution is set to fall in the range of 34 to 42° C. More preferably the reduced pressure of the back surface of the bead, the distance d between the lip of the die and the web, and the temperature of the coating solution are set to fall in the range of 300 to 1000 Pa, in the range of 140 to 300 μm, and in the range of 34 to 42° C., respectively, at the same time.

According to the coating method of this invention for coating a continuously running web with a coating solution fed through a die, leveling treatment is given to the surface of the web before the coating operation, thereby making it possible to eliminate the occurrence of coating uniformity on the surface of the web even when not only non-uniformity in electrification but also irregularities exist on the surface.

If the leveling treatment includes a heating step and a cooling step, the heating step being a step of heating the web with a heating roller in the temperature range of 50 to 125° C. and blowing air in the temperature range of 50 to 125° C. on the web and the cooling step being a step of cooling the web with a cooling roller in the temperature range of 25 to 45° C., more effect can be produced that levels the irregularities on the surface of the web.

### BRIEF DESCRIPTION OF THE DRAWINGS

FIG. 1 is a schematic view of a coating line constructed in accordance with this invention;

FIG. 2 is an enlarged view showing the main part of a coating apparatus that constitutes the coating line shown in FIG. 1;

FIGS. 3A and 3B are views illustrating lapping angles;

FIG. 4 is a view illustrating a dynamic contact line;

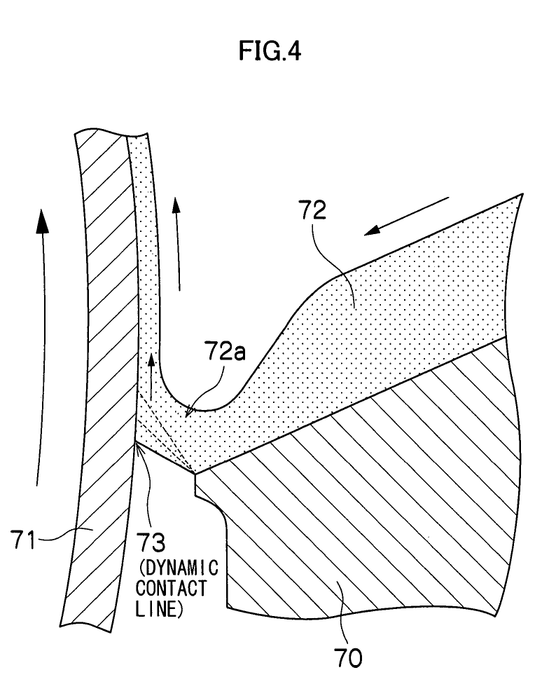

FIG. 5 is a view illustrating a bulk roll;

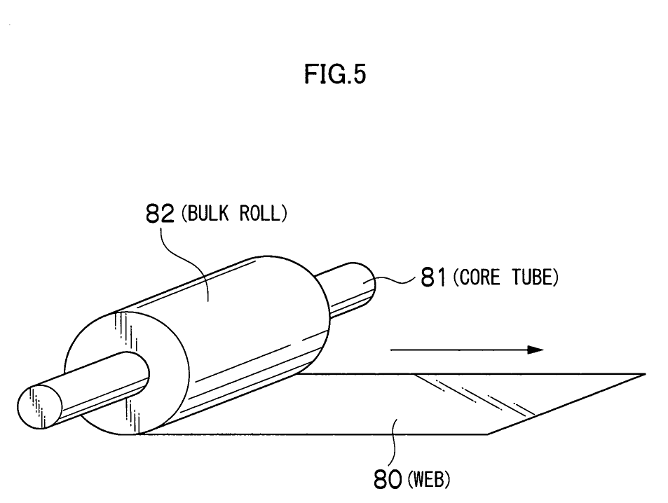

FIGS. 6A and 6B are views illustrating a repeated deformation in cut edge; and

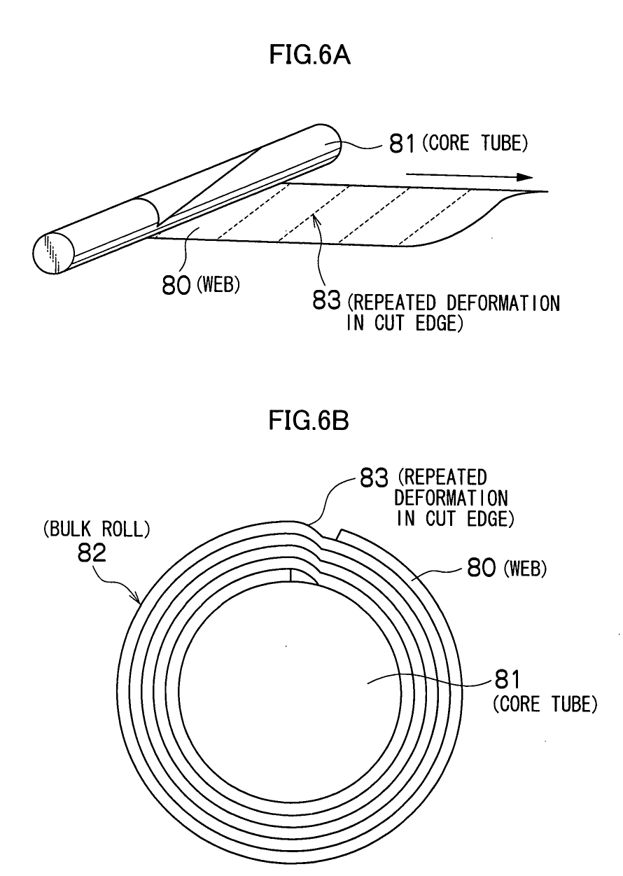

FIG. 7 is a view illustrating a repeated deformation in cut edge.

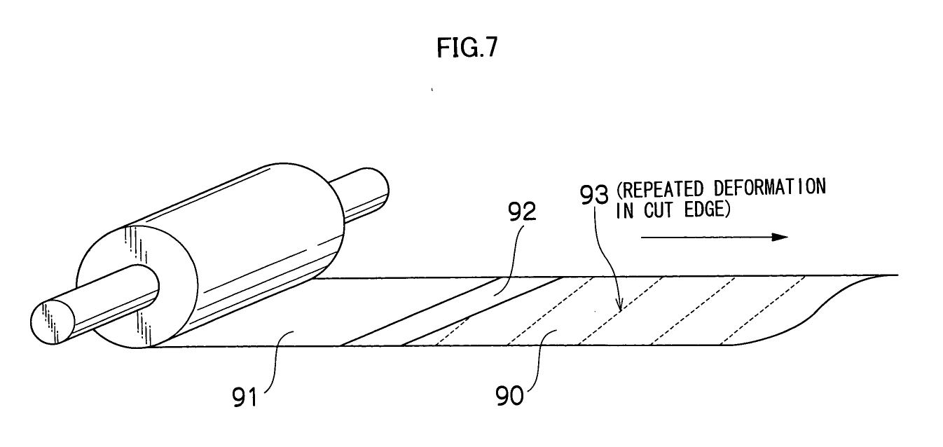

FIG. 8 is a table 1 showing experimental conditions and results of examples 1 to 7 and comparative examples 1 to 4.

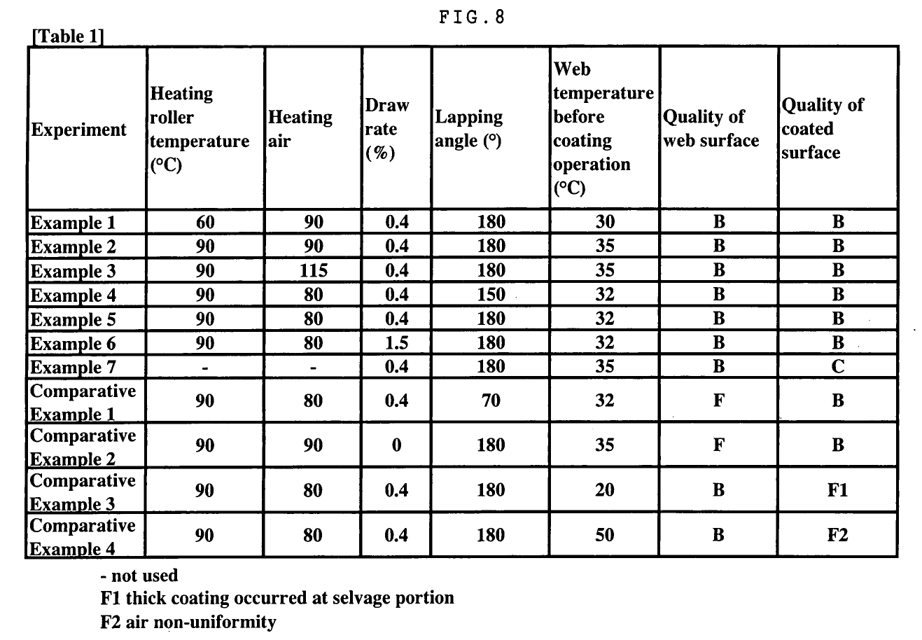

FIG. 9 is a table 2 showing experimental conditions and results of examples 8 to 11 and comparative examples 5 to 6.

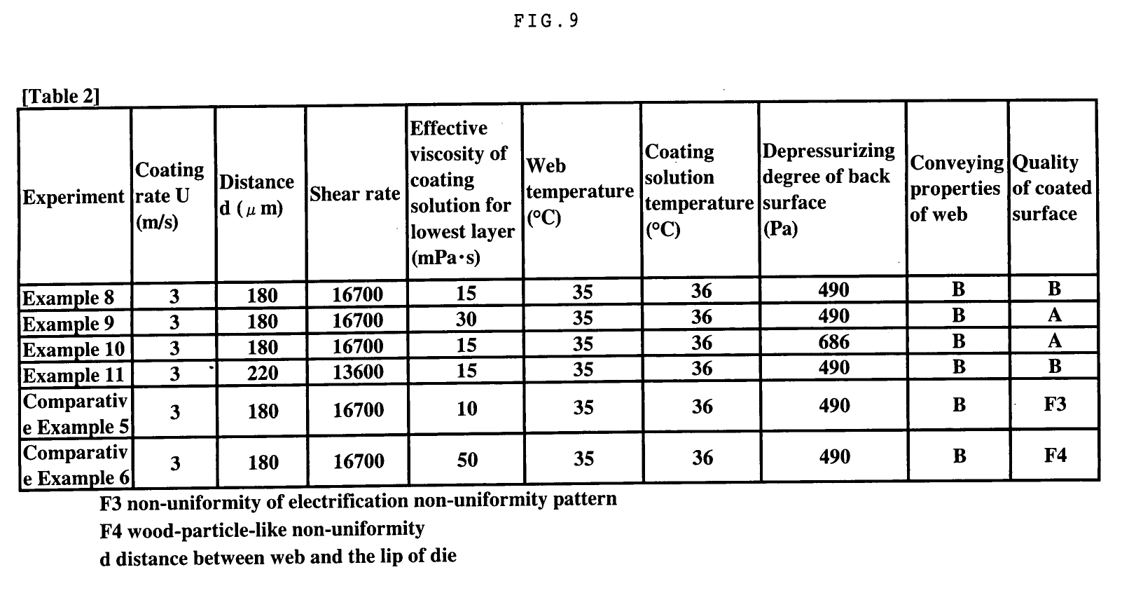

### DETAILED DESCRIPTION OF THE PREFERRED EMBODIMENTS

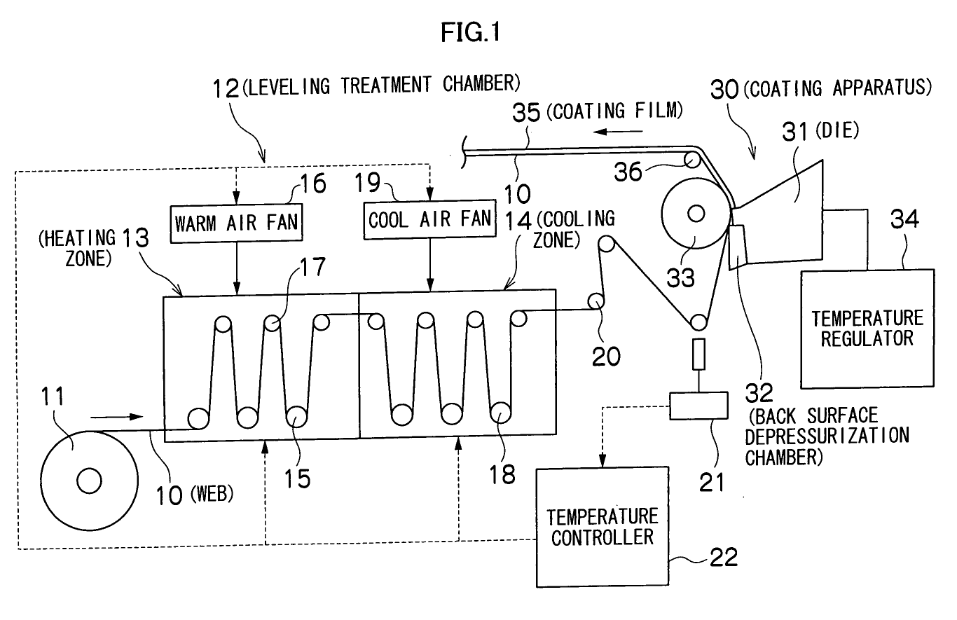

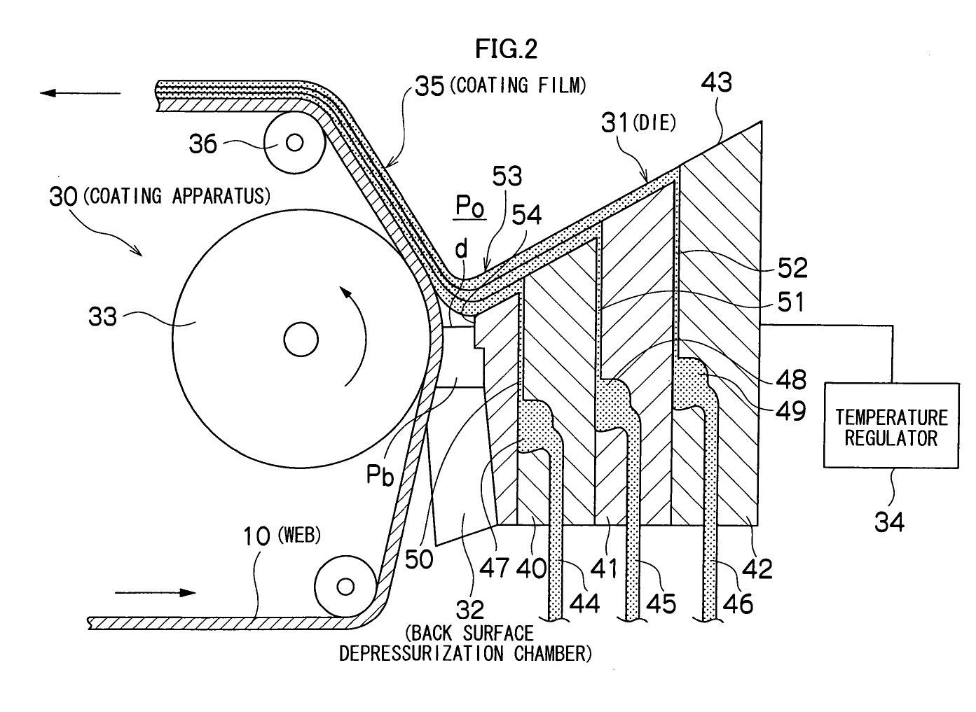

In the following a preferred embodiment of coating method of this invention will be described with reference to accompanying drawings. FIG. 1 is a schematic view illustrating a coating line used in the coating method of this invention and FIG. 2 an enlarged view of the main part of a coating apparatus provided for the coating line of this invention. While this invention is illustrated in the figures in terms of a slide bead coating method in which three coats of coating solutions are applied to a web, it should be understood that this invention is applicable to any type of coating methods for coating a web with coating solutions. And the number of coats applicable to a web is not limited to any specific one.

In the coating line shown in FIG. 1, a web 10 is fed from a feeder 11 to a leveling treatment chamber 12. The leveling treatment chamber 12 includes a heating zone 13 and a cooling zone 14. The web 10 fed from the feeder 11 is first heated in the heating zone 13 of the leveling treatment chamber 12 while being conveyed. The heating of the web 10 is carried out with heating rollers 15. The temperatures of the heating rollers are preferably in the range of 50 to 125° C. to eliminate repeated deformation in cut edges on the web 10. The heating of the web 10 may be carried out by providing a warm air fan 16 in the heating zone 13 and blowing warm air from the warm air fan 16 in the heating zone 13. Heating the web 10 by the warm air from the warm air fan 16 enables the repeated deformation in cut edges to be eliminated. The web 10 in the heating zone 13 may also be heated with the above described heating rollers and by the warm air blown from the warm air fan 16 at the same time. The temperature of the warm air blown from the warm air fan 16 is preferably in the range of 30 to 125° C. to eliminate repeated deformation in cut edges on the web 10.

Conveying the web 10, which is allowed to run in the heating zone 13 with the aid of the heating rollers 15 and conveying rollers 17, in such a manner to make the draw rate of the web 10 positive is preferable to eliminate the repeated deformation in cut edges on the web 10. Specifically, the positive draw rate means that the unit length of the web in the running state is larger than that of the web in the still state, in other words, the web 10 is conveyed while drawn by the heating rollers 15 and the conveying rollers 17. Drawing the web 10 while heating the same in the heating zone 13 in this manner enables repeated deformation in cut edges on the surface of the web 10 to be effectively eliminated. In this invention, preferably the draw rate is in the range of +0.2 to +2.0%. If the draw rate is less than +0.2%, the effect of drawing the web is hard to produce, whereas if the draw rate is more than +2.0%, the web might be cut off while being conveyed. In FIG. 1, a coating line is shown where two kinds of rollers, heating rollers 15 and conveying rollers 17, are provided in the heating zone 13. However, this invention is not limited to the embodiment shown in the figure, as long as rollers of either one type are provided in the heating zone. When conveying rollers 17 alone are provided in the heating zone 13, however, it is necessary to provide a warm air fan 16, as a device which heats the web, in the heating zone.

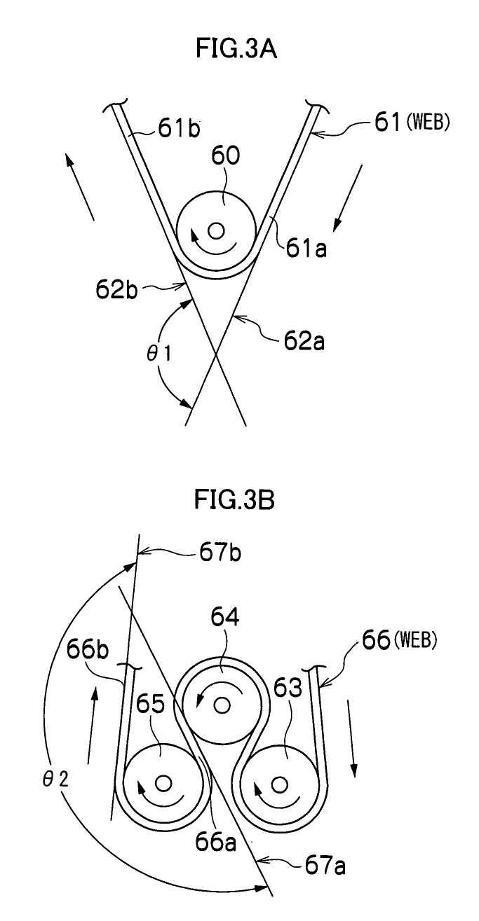

The rollers (heating rollers 15 or conveying rollers 17) provided in the heating zone 13 convey the web 10 while passing the same around them. Preferably the lapping angle of the web in the above state is in the range of 30 to 240 degrees because with such a lapping angle, the web 10 receives tensile force that eliminates repeated deformation in cut edges thereon. The lapping angle is more preferably in the range of 90 to 200 degrees and most preferably in the range of 160 to 200 degrees. The lapping angle will be described with reference to FIG. 3. As shown in FIG. 3A, the term “lapping angle” herein used means the angle θ1 supplementary to the angle between the extension 62a of the web 61a, which moves nearer to a roller 60 before lapping, in the web's running direction and the extension 62b of the web 61b, which moves away from the roller 60, in the direction opposite to the web's running direction. However, as shown in FIG. 3B, in cases where rollers 63, 64 and 65 are arranged, the lapping angle is not defined as the supplementary angle θ1, but as the angle described below. For example, the lapping angle of the web 66 to the roller 65 is defined as the angle θ2 between the extension 67a of the web 66a, which moves nearer to the roller 65, in the web's running direction and the extension 67b of the web 66b, which moves away from the roller 65, in the web's running direction. Further, in cases where the web moving nearer to a roller and the web moving away from the roller are parallel, the lapping angle is defined as 180 degrees. The term “roller” used in the above description include both heating rollers 15 and conveying rollers 17.

In cases where a number of heating rollers 15 are provided in the heating zone 13, preferably the temperatures of the downstream heating rollers are set higher than those of the upstream heating rollers to eliminate repeated deformation in cut edges on the web 10, because doing so allows the web 10 to be heated gradually in the heating zone 13. In such a case, if the difference in temperature between the most downstream heating roller and the most upstream heating roller is in the range of 10 to 50° C., repeated deformation in cut edges on the web 10 can be eliminated effectively.

As described so far, the surface of the web 10 can be leveled by setting the lapping angle of the web to rollers 15 (heating rollers 15 or conveying rollers 17) in the range of 30 to 240 degrees and the draw rate of the web positive. This leveling is referred to as iron effect. Highly effective conditions under which the iron effect is produced are those of allowing the web to stay in the heated state for a long time to increase its temperature and of increasing the contact area of the web with rollers and pressurizing the web for a long time. Accordingly, to achieve an iron effect in the heating zone of certain capacity, it is effective to increase the number of the conveying rollers in the heating zone. Providing an increased number of conveying rollers in the heating zone involves increasing the lapping angle of the web, which in turn increases the contact area of the web with the conveying rollers. Increase in contact area of the web with the rollers means increase in time during which the web is pressurized; thus, the iron effect is synergistically enhanced.

The web 10 fed from the heating zone 13 into the cooling zone 14 is cooled while being conveyed with the aid of cooling rollers 18 provided in the cooling zone 14. Preferably the temperatures of the cooling rollers 18 are in the range of 20 to 50° C. to level the web 10, which has undergone plastic deformation in the heating zone 13, again. The method of cooling the web 10 in the cooling zone 14 is not limited to the above described cooling method, in which cooling is carried out with the aid of the cooling rollers 18. For example, the web 10 may be cooled by providing a cool air fan 19 in the cooling zone 14 and blowing cool air from the cool air fan onto the web. In this case, the temperature of the cool air is lower than that of the web 10 and preferably the temperature is in the range of 20 to 30° C. to retard the rapid cooling of the web 10 and prevent the web 10 from being forcibly deformed.

In cases where a number of cooling rollers 18 are provided in the cooling zone 14, preferably the temperatures of the downstream cooling rollers are set lower than those of the upstream cooling rollers to level the surface of the web 10, because doing so allows the web 10 to be cooled gradually in the cooling zone 14. In such a case, if the difference in temperature between the most downstream cooling roller and the most upstream cooling roller is in the range of 10 to 50° C., the web 10 undergoes plastic deformation efficiently and the surface of the web 10 can be excellently leveled.

Preferably the surfaces of the heating rollers 15 and the cooling rollers 18 are made of hard-chrome-plated stainless steel; however, the material is not limited to any specific one as long as it is not changed, for example fused, at 125° C. Preferably the surfaces of the heating rollers 15 and the cooling rollers 18 are smooth, but grooves may be cut in them. Rollers having such surfaces include, not limited to, mat rollers and dimple rollers. In this invention, the number of the heating rollers 15 and the cooling rollers 18 provided in their respective zones 13, 14 is not limited to any specific one. As a method for controlling the temperature of the heating rollers 15, may be used any known method, such as utilizing heating wire, flowing warm water or blowing warm air. As a method for controlling the temperature of the cooling rollers 18, may be used any known method, such as flowing cool water or blowing cool air.

The web 10 having been fed from the leveling treatment chamber 12 is conveyed with the aid of a number of conveying rollers to a coating apparatus 30. At this point, preferably the temperature of the web 10 before it is coated with coating solutions (hereinafter referred to as web temperature before the coating operation) is in the range of 25 to 45° C. to achieve uniform coating of coating solutions by the coating apparatus 30 and more preferably in the range of 30 to 40° C. The web temperature before the coating operation is measured with a temperature sensor 21 arranged upstream of the coating apparatus 30. The value of the web temperature before the coating operation measured with the sensor 21 is transmitted to a temperature controller 22, and the temperature controller 22 controls, based on the transmitted value, the temperatures of the heating rollers 15 and the warm air fan 16 in the heating zone 13 and those of the cooling rollers 18 and the cool air fan 19 in the cooling zone 14 so that the web temperature before the coating operation falls in the preferable range. It is preferable to electrically charge the surface of the web 10 with a charger (not shown in the figure) before coating the web 10 with coating solutions, because doing so makes easy the coating of coating solutions; however, this invention does not necessarily require such an operation.

The web 10 whose surface has undergone leveling treatment in the leveling treatment chamber 12 is then coated with coating solutions by the coating apparatus 30. The coating apparatus 30 includes: a coating die (hereinafter referred to as die) 31, a back surface depressurization chamber 32, a back-up roller 33 that travels while passing the web 10 around itself, and a temperature regulator 34 fitted to the die 31 to regulate the temperature of coating solutions. The coating solutions having been applied to the surface of the web 10 by the coating apparatus 30 form a coating film 35 which is conveyed to a drying apparatus (not shown in the figure) with the aid of a conveying roller 36 to be produced into a film. Preferably the back-up roller 33 is a metal roller or a roller whose surface is coated with thin ceramic to prevent leakage of charges as disclosed in Japanese Patent Application Publication No. 2-251266; however, any known roller is applicable. In this invention, the coating apparatus 30 does not necessarily require the back surface depressurization chamber 32 and the temperature regulator 34 which regulates the temperature of coating solutions.

The coating method of this invention will be further described with reference to FIG. 2. The die 31 includes three die blocks 40, 41 and 42 as a unit. On the top surface of the die 31 is formed a slide surface 43 which slopes downward toward the back-up roller 33. The die blocks 40, 41 and 42 are provided with manifolds 47, 48 and 49, respectively, and the manifolds 47, 48, 49 are fed with coating. solutions 44, 45, 46, which are to be applied to the web 10 to form a 3-layer liquid film, from coating solution tanks not shown in the figure with variable delivery pumps. The coating solutions 44, 45, 46 may be fed from the middle portion across the width of each of the manifolds 47, 48, 49 or from one end portion of each of the manifolds 47, 48, 49. Any known shape of manifold is applicable to this invention.

The coating solutions 44, 45, 46 having been fed to the manifolds 47, 48, 49 are extruded over the slide surface 43 through slots 50, 51, 52, respectively. The coating solutions 44, 45, 46 having been extruded over the slide surface 43 form a multilayer liquid film 53 which is applied to the web 10 from a lip 54 as a tip of the die 31. In this invention, preferably the distance d between the lip 54 and the web 10 is 140 to 300 μm (that is, 1.4×10⁻⁴ to 3.0×10⁻⁴ m) and more preferably 180 to 240 μm (=1.8×10⁻⁴ to 2.4×10⁻⁴ m). And preferably the coating rate U (m/s) when coating the web with the multilayer liquid film 53 is 0.2 to 6 m/s and more preferably 1 to 4 m/s.

In this invention, preferably the amount of the coating solution 44, which forms the lowest layer of a coating film 35, applied is, not limited to, 5 to 20 ml/m². If the viscosity of the coating solution 44 at a shear rate (U/d, U represents the above described coating rate U and d the distance between the lip 49 and the web 10) is in the range of 15 to 30 mPa·s, occurrence of coating non-uniformity can be retarded and coating film of high quality can be produced even when there exists non-uniformity in electrification on the surface of the web. The viscosity of a coating solution at the shear rate (U/d) is referred to as effective viscosity. In this invention, preferably the shear rate is in the range of 1700 to 43000 (l/s) in terms of the relationship equation (U/d). When a fluid has a small shear rate, the viscosity of the fluid can be taken as almost the same as the viscosity of a solution from which high polymer with a molecular weight of 300000 or more has been removed, and such a viscosity is defined as static viscosity in this invention. When a fluid has a large shear rate, the viscosity of the fluid is almost constant, and such a viscosity is defined as ultimate viscosity in this invention. However, the viscosity of a fluid is decreased with increasing shear rate of the fluid when the value of the shear rate is between the values of the static viscosity and the ultimate viscosity. Thus, the coating method of this invention can be carried out by specifying the viscosity of a fluid at a given shear rate to be an effective viscosity and adjusting the specified effective viscosity. The effective viscosity of the coating solution which forms the lowest layer can be adjusted not only by changing the coating rate U or the distance d between the web and the lip of the die tip, but also by adjusting the viscosity of the coating solution 44 at the time of its preparation.

The back surface depressurization chamber 32 is provided to depressurize the surface of the multilayer liquid film 53 to be applied to the web 10 (hereinafter referred to as back surface). It is known that depressurizing the back surface of the multilayer liquid film 53 enables the occurrence of entrapment to be retarded. In this invention, preferably the back surface reduced pressure, that is, the difference between atmospheric pressure Po on the surface of the multilayer liquid film 53 and atmospheric pressure Pb on the back surface of the same (Po—Pb) is in the range of 300 to 1000 Pa and more preferably in the range of 400 to 700 Pa.

If the temperatures of the coating solutions 44, 45, 46 at the time of their being applied to the web 10 are, not limited to, in the range of 34 to 42° C., the multilayer liquid film 53 is easy to apply to the web 10, and besides, rapid vaporization of the solvent in the multilayer liquid film 53 can be retarded. In FIG. 2, the coating method of this invention is illustrated in terms of an embodiment where the die blocks 40, 41, 42 are provided with the temperature regulator 34 to regulate the temperatures of the coating solutions 44, 45, 46. In this invention, however, the method of regulating the temperatures of the coating solutions 44, 45, 46 is not limited to the embodiment shown in FIG. 2, but the temperatures of the coating solutions 44, 45, 46 may be regulated in advance before the solutions are fed to the die blocks 40, 41, 42.

As a coating apparatus used in this invention, a slide bead type one is preferable, but apparatuses of other types, such as extrusion bead type, slide curtain type and slide extrusion type, may also be used.

Then preferred embodiments of thermal-developable light-sensitive material s used in this invention will be described in detail.

Organic silver salts usable for a thermal-developable light-sensitive material are relatively stable to light, but once heated to 80° C. or more in the presence of photocatalyst having been exposed to light (such as latent image of photosensitive silver halide) and a reducing agent, they form silver images. Organic silver salts may be any organic substances that include a source capable of reducing silver ions. The non-photosensitive organic silver salts are described in Japanese Patent Application Publication No. 10-62899, column nos. 0048 to 0049, European Patent Publication No. 0803764A1, p. 18,1.24 to p. 19,1.37 and European Patent Publication No. 0962812A1. Silver salts of organic acids, particularly silver salts of long-chain aliphatic carboxylic acids (C₁₀ to C₃₀ and preferably C₁₅ to C₂₈) are preferred. Preferred organic silver salts include, for example, silver behenate, silver arachidate, silver stearate, silver oleate, silver laurate, silver caproate, silver myristate, silver palmitate and the mixtures thereof. Of these organic silver salts, silver salts of organic acids having a silver behenate content of 75% by mol or more are preferably used in this invention.

The shape of the organic silver salts usable for a thermal-developable light-sensitive material is not limited to any specific one, and any one of needle-shaped, rod-shaped, flat plate-shaped or scaly organic silver salts may be used.

In this invention, however, scaly organic silver salts are preferred. The term “scaly organic silver salt” herein used is defined as follows. First the shape of each particle of an organic acid silver salt observed under an electron microscope is approximated to be a rectangular solid and the sides of the rectangular solid are represented by a, b and c (c may have the same value as b), respectively, in the order of increasing length and then the value x is calculated using following equation, in which the values of shorter sides a, b are used.

x=b/a

The values x are calculated for about 200 particles and the mean value of the obtained values x is represented by x (mean). If the relation x (mean)≧1.5 holds, the organic acid silver salt is regarded as scaly organic silver salt. Preferably the relation 30≧x (mean)≧1.5 holds and more preferably the relation 20≧x (mean)≧2.0 holds. If the relation 1≦x (mean)<1.5 holds, the organic acid silver salt is regarded as needle-shaped organic acid salt.

In scaly particles, a can be regarded as thickness of flat plate-shaped particles whose principal planes are formed of sides b and c. Preferably the mean value of a is 0.01 μm or more and 0.23 μm or less and more preferably 0.1 μm or more and 0.20 μm or less. The mean value of c/b is preferably 1 or more and 6 or less, more preferably 1.05 or more and 4 or less, much more preferably 1.1 or more and 3 or less, and particularly preferably 1.1 or more and 2 or less.

Preferably the particle size distribution of organic silver salts is that of monodispersed particles. In monodispersed particles, the percentage obtained by dividing the standard deviations of the lengths of minor axis and major axis by the lengths of minor axis and major axis, respectively is preferably 100% or less, more preferably 80% or less and much more preferably 50% or less. The shape of an organic silver salt can be determined from the transmission electron micrograph of an organic silver salt dispersion. Another method of determining the monodispersibility of an organic silver salt is to calculate the standard deviation of the volume weighted mean diameter of the silver salt. And the percentage (coefficient of variation) obtained by dividing the standard deviation by the volume weighted mean diameter is preferably 100% or less, more preferably 80% or less and much more preferably 50% or less. The monodispersibility can be obtained by irradiating organic silver salt particles dispersed in a solution with laser light to measure the fluctuation in scattered light and calculating the particle size (volume weighed mean diameter) using an autocorrelation function of the fluctuation and time change.

As methods of producing and dispersing an organic acid silver salt, any known methods are applicable to this invention. For example, reference can be made to the methods disclosed in Japanese Patent Application Publication No. 10-62899, European Patent Publication No. 0803763A1, and European Patent Publication No. 0962812A1.

When dispersing an organic silver salt in a thermal-developable light-sensitive material, if a photosensitive silver salt is allowed to coexist with the organic silver salt, fog is increased and the sensitivity of the material significantly deteriorates; thus, it is preferable for the material not to contain a photosensitive silver salt when dispersing an organic silver salt in it. In this invention, the amount of a photosensitive silver salt dispersed in aqueous dispersion is 0.1% by mol or less per 1 mol of organic acid silver salt and any photosensitive silver salt is not added positively.

In this invention, an aqueous dispersion of an organic silver salt and an aqueous dispersion of a photosensitive silver salt can be mixed to produce a sensitive material and the mixing ratio of the organic silver salt to the photosensitive silver salt can be selected depending on the objective; however, the ratio of the photosensitive silver salt to the organic silver salt is preferably in the range of 1 to 30% by mol, more preferably in the range of 3 to 20% by mol, and particularly preferably in the range of 5 to 15%. Mixing two kinds or more of aqueous dispersions of organic silver salt and two kinds or more of aqueous dispersions of photosensitive silver salt is a process preferably employed to regulate the photographic characteristics.

In this invention, organic silver salts can be used in a desired amount, but the amount is preferably 0.1 to 5 g/m² and more preferably 1 to 3 g/m² in terms of the amount of silver.

Preferably the thermal-developable light-sensitive material s used in this invention contain a reducing agent for organic silver salts. Reducing agents for organic silver salts may be any substances (preferably organic substances) as long as they reduce silver ions to metal silver. Such reducing agents are described in Japanese Patent Application Publication No. 11-65021, column nos. 0043 to 0045 and European Patent Publication No. 0803764A1, p. 7,1.34 to p. 18,1.12. In this invention, reducing agents of bisphenols (for example, 1,1-bis(2-hydroxy-3,5-dimethylphenyl)-3,5,5-trimethylhexane, 2,2′-methylene bis-(4-methyl-6-tert-buthyl phenol), and 2,2′-methylene bis-(4-ethyl-6-tert-buthyl phenol)) are particularly preferably used. The amount of the reducing agent added is preferably 0.01 to 5.0 g/m² and more preferably 0.1 to 3.0 g/m², and the amount is preferably 5 to 50% by mol and more preferably 10 to 40% by mol per 1 mol of silver contained the surface having an image forming layer. Preferably the reducing agent is contained in the image forming layer.

When adding a reducing agent to coating solutions so that a photosensitive material should contain the same, the reducing agent may take any form such as solution, emulsion or dispersion of solid fine particles.

Well-known emulsifying methods include, for example, a method in which a reducing agent is dissolved in oil, such as dibutyl phthalate, tricresyl phosphate, glyceryl triacetate or diethyl phthalate, or in a co-solvent such as ethyl acetate or cyclohexanone and the emulsion of the reducing agent is formed mechanically.

Solid fine particle dispersing methods include, for example, a method in which powder of a reducing agent is dispersed in an appropriate solvent, such as water, with a ball mill, colloid mill, oscillating mill, sand mill, jet mill or roller mill or ultrasonic wave to form a dispersion of solid. In forming a dispersion of solid, a protective colloid (e.g. polyvinyl alcohol) and a surfactant (e.g. an anionic surfactant such as sodium tri-isopropylnaphthalenesulfonate (a mixture of the compounds having three isopropyl groups at different positions)) may be used. An aqueous dispersion may contain a preservative (e.g. sodium salt of benzisothiazolinone).

In this invention, phenol derivatives having the formula (A), which are described in Japanese Patent Application No. 11-73951, are preferably used as an development accelerator.

The halogen composition of photosensitive silver halides used in this invention is not limited to any specific one. Silver chloride, silver chloride bromide, silver bromide, silver iodide bromide and silver iodide chloride bromide can be used. The distribution of halogen composition in the particles may be uniform or change stepwise or change continuously. Silver halide particles having a core/shell structure are preferably used. Preferably such a core/shell structure is a 2- to 5-layered structure and more preferably 2- to 4-layered structure. The technique for localizing silver bromide on the surface of silver chloride particles or silver bromide chloride particles can also be preferably used.

Methods for forming photosensitive silver halides are well-known in the art. For example, those described in Research Disclosure, No. 17029, Jun. 1978 and U.S. Pat. No. 3,700,458 can be used. Specifically, the methods can be used in which a silver-supplying compound and a halogen-supplying compound are added to gelatin or some other polymer solution to prepare a photosensitive silver halide and the photosensitive halide is mixed with an organic silver salt. The methods described in Japanese Patent Application Publication No. 11-119374, column nos. 0217 to 0224 and Japanese Patent Application Nos. 11-98708 and 11-84182 are also preferably used.

Preferably the particle size of each photosensitive silver halide is small to reduce the occurrence of white cloudiness after image formation. Specifically, it is 0.20 μm or less, preferably 0.01 μm or more and 0.15 μm or less and more preferably 0.02 μm or more and 0.12 μm or less. The term “particle size” herein used means, when the silver halide particle is a so-called normal crystal such as cubic or octahedral crystal or a particle other than normal crystal such as spherical or rod-shaped particle, the diameter of an imaginary sphere having a volume equivalent to that of the silver halide particle and, when the silver halide particle is a flat plate-shaped particle, the diameter of an imaginary circle image having an area equivalent to the projected area of the principal plane of the flat-plate particle.

The shapes of silver halide particles include, for example, cubic, octahedral, flat plate-like, spherical, rod-like and potato-like shapes. In this invention, cubic particles are particularly preferably used. Silver halide particles whose corners are rounded off can also be preferably used. The index of plane (Miller indices) of the external surface of photosensitive silver halide particles is not particularly limited; however, preferably the plane {100}, whose spectral sensitization efficiency is high when a sensitizing dye is adsorbed on the particle surface, accounts for a high percentage of the surface. The percentage is preferably 50% or more, more preferably 65% or more and much more preferably 80% or more. The percentage of the plane {100}, based on Miller indices, can be obtained by the method described in T. Tani, J. Imaging Sci., 29, 165 (1985) which utilizes the adsorption dependency of the plane {111} and the plane {100} in the adsorption of sensitizing dyes.

The photosensitive silver halide particles used in this invention contain metals or metal complexes of the groups VIII to X in the periodic table (the groups I to XVIII are shown). Preferred metals or central metals of metal complexes of the groups VIII to X in the periodic table are rhodium, ruthenium and iridium. The photosensitive silver halide particles may contain only one kind of metal complex or two or more kinds of complexes each having the same or different metals in combination. The content of the metal(s) or metal complex(es) in the particles per 1 mol of silver is preferably in the range of 1×10⁻⁹ mol to 1×10⁻³ mol. The processes of adding these heavy metals and metal complexes are described in Japanese Patent Application Publication No. 7-225449, Japanese Patent Application Publication No. 11-65021, column nos. 0018 to 0024 and Japanese Patent Application Publication No. 11-119374, column nos. 0227 to 0240.

In this invention, preferably the silver halide particles contain an iridium compound. Examples of iridium compounds are hexachloroiridium, hexaammineiridium, trioxalatoiridium and hexacyanoiridium. These iridium compounds are used in the form of an aqueous solution or an appropriate solvent solution. And a method can be used which is commonly used to stabilize solutions of iridium compounds, specifically a method in which an aqueous solution of a hydrogen halide (e.g. hydrochloric acid, bromic acid and hydrofluoric acid) or an alkali halide (e.g. KCl, NaCl, KBr and NaBr) is added to the solutions of iridium compounds. Instead of using water-soluble iridium, it is possible to add additional silver halide particles having been doped with iridium at the time of preparing a silver halide and dissolving the iridium in the silver halide. The amount of the iridium compounds added is preferably in the range of 1×10⁻⁸ mol to 1×10⁻³ mol and more preferably in the range of 1×10⁻⁷ mol to 5×10⁻⁴ mol per 1 mol of silver halide.

The metal atoms which the silver halide particles used in this invention can contain (e.g. [Fe(CN)₆]⁴⁻) and the process of desalting or chemically sensitizing silver halide emulsion are described in Japanese Patent Application Publication No. 11-84574, column nos. 0046 to 0050 and Japanese Patent Application Publication No. 11-65021, column nos. 0025 to 0031, and Japanese Patent Application Publication No. 11-119374, column nos. 0242 to 0250.

Gelatin which the photosensitive silver halide emulsion used in this invention can contain can be selected from among various kinds of gelatin. To keep in a good state the dispersion of the photosensitive silver halide emulsion in the coating solution that contains an organic silver salt, it is preferable to use low-molecular-weight gelatin having a molecular weight of 500 to 60,000. The low-molecular-weight gelatin may be used at the time of particle formation or particle dispersion after desalting; however, preferably it is used at the time of particle dispersion after desalting.

Sensitizing dyes applicable to this invention can be advantageously selected from among those which are capable of spectrally sensitizing the silver halide particles in a desired wavelength region when adsorbed onto the silver halide particles and have spectral sensitivity suitable for the spectral characteristics of the exposure source. Such sensitizing dyes and the processes for adding sensitizing dyes are described in Japanese Patent Application Publication No. 11-65021, column nos. 0103 to 0109, in Japanese Patent Application Publication No. 10-186572 as the compounds having the general formula (II), in Japanese Patent Application Publication No. 11-119374 as the dyes having the general formula (I) and in column no. 0106, in U.S. Pat. No. 5,510,236, in U.S. Pat. No. 3,871,887 as the dye described in example 5, in Japanese Patent Application Publication No. 2-96131, in Japanese Patent Application Publication No. 59-48753 as the dyes, and in European Patent Publication No. 0803764A1, p. 19,1.38 to p. 20,1.35. These sensitizing dyes may be used independently or in the form of a blend of two or more kinds. In this invention, the time when a sensitizing dye is added to the silver halide emulsion is preferable after the desalting step and before the coating step. and more preferably after the desalting step and before the beginning of chemical maturation.

In this invention, a desired amount of sensitizing dye can be added according to the performance of the thermal-developable light-sensitive material , in terms of its sensitivity and fogging; however, the amount of the sensitizing dye added is preferably in the range of 10⁻⁶ mol to 1 mol and more preferably in the range of 10⁻⁴ mol to 10⁻¹ mol per 1 mol of silver halide in the photosensitive layer.

Preferably the photosensitive silver halide particles used in this invention is chemically sensitized by sulfur sensitization process, selenium sensitization process or tellurium sensitization process. Compounds preferably used in the sulfur sensitization process, selenium sensitization process or tellurium sensitization process can be selected from among known compounds, for example, the compounds described in Japanese Patent Application Publication No. 7-128768. In this invention the tellurium sensitization process is particularly preferred, and compounds described in Japanese Patent Application Publication No. 11-65021, column no. 0030 and compounds having the general formulae (II), (III) and (IV) described in Japanese Patent Application Publication No. 5-3132841 are much more preferred.

In this invention, chemical sensitization can be done at any time after the particle forming step and before the coating step, specifically after the desalting step and (1) before the spectrally sensitizing step, (2) at the same time as the spectrally sensitizing step, (3) after the spectrally sensitizing step or (4) immediately before the coating step. However, preferably chemical sensitization is done after the spectrally sensitizing step.

The amount of the sulfur, selenium or tellurium sensitizer used in this invention varies depending on the silver halide particles used and the chemical maturation conditions; however, the amount is in the range of about 10⁻⁸ to 10⁻² mol and preferably in the range of about 10⁻⁷ to 10⁻³ mol per 1 mol of silver halide. The conditions under which the photosensitive silver halide particles used in this invention is chemically sensitized are not particularly limited. The chemical sensitization is done at pH of 5 to 8, pAg of 6 to 11 and at a temperature of about 40 to 95° C.

To the silver halide emulsion used in this invention, a thiosulfonic compound may be added by the process disclosed in European Patent Publication No. 293,917.

In the photosensitive material used in this invention, only one kind of photosensitive silver halide emulsion or tow or more kinds of photosensitive silver halide emulsions (e.g. those different in average particle size, halogen composition or crystal habit and conditions for chemical sensitization) in combination may be used. Use of more than one kind of photosensitive silver halides which are different in sensitivity makes it possible to control the gradation of images. Examples of related techniques are those disclosed in Japanese Patent Application Publication Nos. 57-119341, 53-106125, 47-3929, 48-55730, 46-5187, 50-73627 and 57-150841. Preferably the difference in sensitivity is 0.2 logE or more in terms of emulsion.

The amount of photosensitive silver halides added is preferably 0.03 to 0.6 g/m², more preferably 0.05 to 0.4 g/m² and most preferably 0.1 to 0.4 g/m² in terms of the amount of silver coated per 1 m² of photosensitive material. The amount of the same is preferably 0.01 mol or more and 0.5 mol or less and more preferably 0.02 mol or more and 0.3 mol or less per 1 mol of organic silver salt.

Processes for mixing a photosensitive silver halide and an organic silver salt, which are prepared separately, include, for example, a process in which a prepared photosensitive silver halide and a prepared organic silver salt are mixed in a ball mill, sand mill, colloid mill, oscillating mill or homogenizer; and a process in which a photosensitive silver halide having been prepared in proper timing during the preparation of an organic silver salt is mixed with the organic silver salt under preparation. The mixing processes and conditions are not particularly limited as long as the effects of this invention are fully achieved. Mixing two or more kinds of dispersions of organic silver salt and two or more kinds of aqueous dispersions of photosensitive silver salt is a preferable process to control the photographic characteristics.

The preferable time when adding a silver halide to the coating solution for the image forming layer used in this invention is 180 minutes to immediately before the coating of the coating solution and preferably 60 minutes to 10 seconds before the coating of the coating solution; however, the mixing process and conditions are not limited to any specific process or conditions as long as the effects of this invention are fully achieved. Concrete examples of mixing processes are a process in which the mixing is carried out in a tank which is designed so that the average residence time of the mixture calculated using the flow rate of the silver halide added and the amount of the coating solution fed to the coater becomes a desired time; and a process using a static mixer which is described in N. Harnby, M. F. Edwards and A. W. Nienow, Liquid Mixing Technology (The Nikkan Kogyo Simbun Ltd., translated by Koji Takahashi, 1989), chapter 8.

Any polymer can be used for the binder for the organic-silver-salt-containing layer used in this invention. A suitable binder is transparent or translucent and generally colorless and can be selected from among natural polymers, synthetic resins, synthetic polymers and copolymers, and media that form films, such as gelatin, gum arabic, poly(vinyl alcohol), hydroxyethyl cellulose, cellulose acetate, cellulose acetate butylate, poly(vinyl pyrrolidone), casein, starch, poly(acrylic acid), poly(methyl methacrylate), poly(vinyl chloride), poly(methacrylic acid), styrene-maleic anhydride copolymer, styrene-acrylonitrile copolymer, styrene-butadiene copolymer, poly(vinyl acetal) (e.g. poly(vinyl formal) and poly(vinyl butylal)), polyesters, polyurethanes, phenoxy resin, poly(vinylidene chloride), polyepoxides, polycarbonates, poly(vinyl acetate), cellulose esters and polyamides. The binder may be formed using water, an organic solvent or an emulsion.

In this invention, when the organic-silver-salt-containing layer is formed by coating and drying a coating solution in which water accounts for 30% by mass or more of its solvent, if the binder in the organic-silver-salt-containing layer is formed of a latex of polymer which is soluble or dispersible in an aqueous solvent (water solvent) and whose equilibrium moisture content at 25° C., 60% RH is 2% by mass or less, characteristics are improved. The most preferred form of binder is one prepared so that its ionic conductivity is 2.5 mS/cm, and one example of the processes for preparing such a binder is to purify a synthesized polymer with a separation membrane.

The term “aqueous solvent in which a polymer is soluble or dispersible” herein used means water or water with 70% by mass or less of water miscible organic solvent mixed therein. Water miscible organic solvents include, for example, alcohol solvents such as methyl alcohol, ethyl alcohol and propyl alcohol; cellosolve solvents such as methyl cellosolve, ethyl cellosolve and butyl cellosolve; ethyl acetate; and dimethylformamide.

In this specification, the term “aqueous solvent” is also used for a system in which polymer is not dissolved thermodynamically, but exists in the so-called dispersed state.

The “equilibrium moisture content at 25° C., 60% RH” can be expressed by the following equation using the weight W1 of polymer at a conditioned moisture equilibrium in an atmosphere of 25° C., 60% RH and the weight W0 of polymer in the absolute dry state.

Equilibrium moisture content at 25° C., 60% RH={(W1-W0)/W0}×100 (% by mass)

For the definition and the method of measuring moisture content, Polymer Material Testing Method, A Series of Lectures on Polymer Engineering 14 (edited by Society of Polymer Science, Japan, Chijinsyokan) can be consulted.

Preferably the equilibrium moisture content at 25° C., 60% RH of the binder polymer used in this invention is 2% by mass or less, more preferably 0.01% by mass or more and 1.5% by mass or less, and much more preferably 0.02% by mass or more and 1% by mass or less.

In this invention, polymers dispersible in an aqueous solvent are particularly preferably used. Examples of such dispersions of polymer are latices in which fine particles of water-insoluble hydrophobic polymer are dispersed and dispersions in which polymer molecules are dispersed in the molecule state or in the form of micelles. Both are preferably used. The average particle size of the dispersed particles is preferably in the range of 1 to 50000 nm and more preferably in the range of 5 to 1000 nm. The particle size distribution of the dispersed particles is not limited to any specific one, and both polymers having a wide particle size distribution and monodisperse polymers may be used.

Examples of polymers dispersible in an aqueous solvent and preferably used in this invention are hydrophobic polymers such as acrylic resin, polyester resin, rubber resin (e.g. SBR resin), polyurethane resin, vinyl chloride resin, vinyl acetate resin, vinylidene chloride resin and polyolefin resin. These polymers may be straight-chain polymers, branched polymers, crosslinked polymers, homopolymers formed from a single monomer, or copolymers formed from two or more kinds of monomers. When the polymers are copolymers, they may be random copolymers or block copolymers. The molecular weights of these polymers are preferably 5000 to 1000000 and more preferably 10000 to 200000 in terms of number average molecular weight. Use of the polymers having too a low molecular weight is not preferable because it makes the mechanical strength of the emulsion layer insufficient and use of the polymers having too a high molecular weight is not preferable either because it makes the film forming properties poor.

Concrete examples of preferable polymer latices are as follow. In the following, polymer latices are shown in terms of raw material monomers, the values in parentheses are in % by mass, and the molecular weight means a number average molecular weight.
P-1; latex of -MMA(70)-EA(27)-MAA(3)- (molecular weight 37000)
P-2; latex of -MMA(70)-2EHA(20)-St(5)-AA(5)- (molecular weight 40000)
P-3; latex of -St(50)-Bu(47)-MAA(3)- (molecular weight 45000)
P-4; latex of -St(68)-Bu(29)-AA(3)- (molecular weight 60000)
P-5; latex of -St(70)-Bu(27)-IA(3)- (molecular weight 120000)
P-6; latex of -St(75)-Bu(24)-AA(1)- (molecular weight 108000)
P-7; latex of -St(60)-Bu(35)-DVB(3)-MAA(2)- (molecular weight 150000)
P-8; latex of -St(70)-Bu(25)-DVB(2)-AA(3)- (molecular weight 280000)
P-9; latex of -VC(50)-NMA(20)-EA(20)-AN(5)-AA(5)- (molecular weight 80000)
P-10; latex of -VDC(85)-NMA(5)-EA(5)-MAA(5)- (molecular weight 67000)
P-11; latex of -Et(90)-MAA(10)- (molecular weight 12000)
P-12; latex of -St(70)-2EHA(27)-AA(3) (molecular weight 130000)
P-13; latex of -MMA(63)-EA(35)-AA(2) (molecular weight 33000)

The abbreviations used in the above structures each represent the following monomers. MMA; methyl methacrylate, EA; ethyl acrylate, MAA; methacrylic acid, 2EHA; 2 ethylhexyl acrylate, St; styrene, Bu; butadiene, AA; acrylic acid, DVB; divinylbenzene, VC; vinyl chloride, AN; acrylonitrile, VDC; vinylidene chloride, Et; ethylene, IA; itaconic acid.

The polymer latices described above are commercially available and the following polymers are applicable. Examples of acrylic resins are Cevian A-4635, 46583, 4601 (Daicel Chemical Industries, Ltd.), Nipol Lx811, 814, 821, 820 and 857 (Nippon Zeon Co., Ltd.). Examples of polyesters are FINETEX ES650, 611, 675, 850 (Dainippon Ink and Chemicals, Inc.), WD-size and WMS (Eastman Chemical). Examples of polyurethanes are HYDRAN AP10, 20, 30 and 40 (Dainippon Ink and Chemicals, Inc.). Examples of rubber resins are LACSTAR 7310K, 3307B, 4700H, 7132C (Dainippon Ink and Chemicals, Inc.), Nipol Lx 416, 410, 438C and 2507 (Nippon Zeon Co., Ltd.). Examples of vinyl chloride resins are G351 and G576 (Nippon Zeon Co., Ltd.). Examples of vinylidene chloride resins are L502 and L513 (Asahi Chemical Industry Co., Ltd.). Examples of olefin resins are Chemipearl S120 and SA100 (Mitsui Petrochemical Industries, Ltd.).

These polymer latices may be used independently or in the form of a blend of two or more kinds depending on the situation.

The latices of a styrene-butadiene copolymer are particularly preferably used in this invention. Preferably the weight ratio of the styrene monomer unit to the butadiene monomer unit is 40:60 to 95:5. Preferably the percentage of the styrene monomer unit and the butadiene monomer unit to the copolymer is 60 to 99% by mass. Preferable molecular weight range is the same as above.

The latices of a styrene-butadiene copolymer preferably used in this invention include, for example, the above described P-3 to P-8 and commercially available latices such as LACSTAR-3307B, 7132C and Nipol Lx416.

To the organic-silver-salt-containing layer of the photosensitive material used in this invention, a hydrophilic polymer such as gelatin, polyvinyl alcohol, methyl cellulose, hydroxypropyl cellulose or carboxymethyl cellulose may be added. The amount of the hydrophilic polymer added is preferably 30% by mass or less and more preferably 20% by mass or less to the total amount of the binder contained in the organic-silver-salt-containing layer.

The organic-silver-salt-containing layer (that is, the image forming layer) used in this invention is preferably formed using a polymer latex. The amount of the binder added to the organic-silver-salt-containing layer is such that the whole binder/organic silver salt weight ratio is in the range of 1/10 to 10/1 and preferably in the range of 1/5 to 4/1.

The organic-silver-salt-containing layer usually serves as a photosensitive layer (emulsion layer) that contains a photosensitive silver halide as a photosensitive silver salt and, in this case, the whole binder/silver halide weight ratio is preferably in the range of 400 to 5 and more preferably in the range of 200 to 10.

The total amount of the binder contained in the image forming layer used in this invention is preferably in the range of 0.2 to 30 g/m² and more preferably in the range of 1 to 15 g/m². The image forming layer used in this invention may contain, for example, a crosslinking agent for crosslinking the molecular chains of the polymers and a surfactant for improving the coating properties of the photosensitive material.

In this invention, the solvent (“solvent” herein used means a solvent together with a dispersing medium for simplification) used in the coating solution for the organic-silver-salt-containing layer of the photosensitive material is an aqueous solvent that contain 30% by mass of water. As an ingredient other than water, any water-miscible organic solvent, such as methyl alcohol, ethyl alcohol, isopropyl alcohol, methyl cellosolve, ethyl cellosolve, dimethylformamide or ethyl acetate, may be used. The water content in the solvent used in the coating solution is preferably 50% by mass or more and more preferably 70% by mass or more. Examples of preferred solvent compositions are: water; water/methyl alcohol=90/10; water/methyl alcohol=70/30; water/methyl alcohol/dimethylformamide=80/15/5; water/methyl alcohol/ethyl cellosolve=85/10/5; and water/methyl alcohol/isopropyl alcohol=85/10/5 (the values are in % by mass).

Examples of anti-fogging agents, stabilizers and stabilizer precursors usable in this invention are those described in Japanese Patent Application Publication No. 10-62899, column no. 0070 and European Patent Publication No. 0803764A1, p. 20,1.57 to p. 21,1.7. The anti-fogging agents preferably used in this invention are organic halides and examples of such organic halides are disclosed in Japanese Patent Application Publication No. 11-65021, column nos. 0111 to 0112. Particularly preferable are the organic halogen compounds having the formula (P) described in Japanese Patent Application No. 11-87297 and the organic polyhalogen compounds (concrete examples are tribromomethylnaphthyl sulfone, tribromomethylphenyl sulfone and tribromomethyl(4-(2,4,6-trimethylphenyl sulfonyl) phenyl) sulfone) having the general formula (II) described in Japanese Patent Application Publication No. 10-339934.

Processes for adding an anti-fogging agent to the photosensitive material used in this invention include, for example, the process described above in connection with the process for adding a reducing agent. And preferably the organic polyhalogen compound is added in the form of a dispersion of solid fine particles.

Other anti-fogging agents include, for example, the mercury(II) salt described in Japanese Patent Application Publication No. 11-65021, column no. 0113, benzoic acid described in Japanese Patent Application Publication No. 11-65021, column no. 0114, the salicylic acid derivatives having the formula (Z) described in Patent Application 11-87297 and the formalin scavenger compounds having the formula (S) described in Patent Application 11-23995.

The thermal-developable light-sensitive material used in this invention may contain an azolium salt so as to prevent the occurrence of fog. Examples of azolium salts are the compounds having the general formula (XI) described in Japanese Patent Application Publication 59-193447, the compounds described in Japanese Examined Application Publication 55-12581 and the compounds having the general formula (II) described in Japanese Patent Application Publication 60-153039. An azolium salt may be added to any part of the photosensitive material; however, preferably it is added to the side including a photosensitive layer and more preferably to the organic-silver-salt-containing layer. An azolium salt may be added at any time during the preparation of coating solutions. When added to the organic-silver-salt-containing layer, the salt may be added at any time during the preparation of an organic silver salt and during the preparation of coating solutions, but preferably it is added after the preparation of an organic silver salt and immediately before the application of coating solutions. An azolium salt may be added by any process, for example, it may be added in the form of a powder, a solution or a dispersion of fine particles. It may also be added in the form of a solution of a mixture of a sensitizing dye, a reducing agent, a toner, etc. In this invention, an azolium salt may be added in any amount; however, the amount is preferably 1×10⁻⁶ mol or more and 2 mol or less and more preferably 1×10⁻³ mol or more and 0.5 mol or less per 1 mol of silver.

The thermal-developable light-sensitive material used in this invention may contain a mercapto compound, a disulfide compound and a thione compound so as to control developing, that is, retard or accelerate developing, to improve its spectral sensitization efficiency and to improve its shelf life before and after developing. Examples of such compounds are the compounds described in Japanese Patent Application Publication No. 10-62899, column nos. 0067 to 0069; the compounds having the general formula (1) described in Japanese Patent Application Publication No. 10-186572, their concrete examples being described in column nos. 0033 to 0052; the compounds described in European Patent Publication No. 0803764A1, p. 20,11.36 to 56; and the compounds described in Japanese Patent Application No. 11-273670. Of the above described compounds, mercapto-substituted heterocyclic aromatic compounds are preferable.

In this invention, it is preferable to use a compound with a phosphoryl group and more preferable to use a phosphine oxide. Concrete examples of phosphine oxides are triphenylphosphine oxide, tri-(4-methylphenyl)phosphine oxide, tri-(4-methoxyphenyl)phosphine oxide, tri-(t-butyl-phenyl)phosphine oxide, tri-(3-methylphenyl)phosphine oxide and trioctylphosphine oxide. The compounds with a phosphoryl group used in this invention can be introduced into the photosensitive material in the same manner as the above described reducing agents and polyhalogen compounds. The amount of the compound with a phosphoryl group added to the photosensitive material is preferably in the range of 0.1 to 10 and more preferably in the range of 0.1 to 2.0 to the adding ratio (molar ratio) of the reducing agent. And it is much more preferably in the range of 0.2 to 1.0.

To the thermal-developable light-sensitive material used in this invention, preferably a toner is added. Examples of toners are described in Japanese Patent Application Publication No. 10-62899, column nos. 0054 to 0055; European Patent Publication No. 0803764A1, p. 21,1.23 to 48; and Japanese Patent Application No. 10-213487. Preferred toners are phthalazinone, the derivatives or metal salts thereof, or the derivatives of 4-(1-naphthyl)phthalazinone, 6-chlorophthalazinone, 5,7-dimethoxyphthalazinone and 2,3-dihydro-1,4-phthalazindione; the combinations of phthalazinone and the derivatives of phthalic acid (e.g. phthalic acid, 4-methylphthalic acid, 4-nitrophthalic acid and tetrachlorophthalic anhydride); phthalazine-type compounds group (phthalazine, the derivatives or metal salts of phthalazine r the derivatives of 4-(1-naphthyl)phthalazine, 6-isopropylphthalazine, 6-t-butylphthalazine, 6-chlorophthalazine, 5,7-dimethoxyphthalazine and 2,3-dihydro-phthalazine); and the combinations of phthalazine-type compounds and derivatives of phthalic acid (e.g. phthalic acid, 4-methylphthalic acid, 4-nitrophthalic acid and tetrachlorophthalic anhydride). Of the above, the combinations of phthalazine-type compounds and the derivatives of phthalic acid are particularly preferably used.

Plasticizers and lubricants applicable to the photosensitive layer used in this invention are described in Japanese Patent Application Publication No. 11-65021, column no. 0117; examples of ultra-hardening agents for forming ultra-hard images are described in Japanese Patent Application Publication No. 11-65021, column no. 0118, Japanese Patent Application Publication No. 11-223898, column nos. 0136 to 0193, as the compounds of formulae (H), (1)-(3) and (A) and (B) in Japanese Patent Application No. 11-87297, and as the compounds of general formula (III)-(V) (concrete compounds of [chemical formula] 21 to 24) in Japanese Patent Application No. 11-91652, and hardening development accelerators are described in Japanese Patent Application Publication No. 11-65021, column no. 0102 and Japanese Patent Application Publication No. 11-223898, column nos. 0194 to 0195. The process and amount of the nucleating agent added are described in Japanese Patent Application Publication No. 11-223898, column nos. 0182 to 0183.

When using formic acid or a formate as a strong protective covering substance, preferably it is added to the image forming layer that contains a photosensitive silver halide in amounts of 5 mmol or less and more preferably 1 mmol or less per 1 mol of silver.

When using a nucleating agent for the heat developing photosensitive material used in this invention, preferably an acid formed by the hydration of diphosphorus pentaoxide or the salt thereof is used in combination. Examples of acids formed by the hydration of diphosphorus pentaoxide or the salts thereof are metaphosphoric acid (metaphosphate), pyrophosphoric acid (pyrophosphate), orthophosphoric acid (orthophosphate), triphosphoric acid (triphosphate), tetraphosphoric acid (tetraphosphate) and hexametaphosphoric acid (hexametaphosphate). Acids formed by the hydration of diphosphorus pentaoxide or the salts thereof particularly preferably used in this invention are orthophosphoric acid (orthophosphate) and hexametaphosphoric acid (hexametaphosphate). Concrete examples of the salts are sodium orthophosphate, sodium dihydrogenorthophosphate, sodium hexametaphosphate and ammonium hexametaphosphate.

The amount of the acid formed by the hydration of diphosphorus pentaoxide or the salt thereof used in this invention (the amount of coating per 1 m² of photosensitive material) may be determined desirably according to the performance of the photosensitive material, in terms of sensitivity and fogging; however, the amount is preferably in the range of 0.1 to 500 mg/m² and more preferably in the range of 0.5 to 100 mg/m².

The thermal-developable light-sensitive material used in this invention can be provided with a surface protective layer so as to prevent the image forming layer from sticking on it. Such a surface protective layer is described in Japanese Patent Application Publication No. 11-65021, column nos. 0119 to 0120.

As a binder used for the surface protective layer of the thermal-developable light-sensitive material used in this invention, not only gelatin, but also polyvinyl alcohol (PVA) is preferably used. PVAs include: for example, PVA-105 as a fully saponified PVA; PVA-205 and PVA-335 as a partially saponified PVA; and MP-203 as a denaturated polyvinyl alcohol (all brand names, by Kuraray Co., Ltd.). The amount of the polyvinyl alcohol of the protective layer (per 1 layer) coated (per 1 m² of substrate) is preferably 0.3 to 4.0 g/m² and more preferably 0.3 to 2.0 g/m².

When using the thermal-developable light-sensitive material used in this invention in applications where dimensional change is a concern, preferably polymer latices are used both for the protective layer and for the back layer. Such polymer latices are described in T. Okuda and H. Inagaki (ed.), Synthetic Resin Emulsion (High Polymer Publishing Association, 1978), T. Sugimura, Y. Kataoka, S. Suzuki and K. Kasahara (ed.), Application of Synthetic Latices (High Polymer Publishing Association, 1993) and S. Muroi, Chemistry of Synthetic Latices (High Polymer Publishing Association, 1970). Concrete examples of polymer latices are: a latex of methyl methacrylate (33.5% by mass)/ethyl acrylate (50% by mass)/methacrylic acid (16.5% by mass) copolymer; a latex of methyl methacrylate (47.5% by mass)/butadiene (47.5% by mass)/itaconic acid (5% by mass) copolymer; a latex of ethyl acrylate/methacrylic acid; a latex of methyl methacrylate (58.9% by mass)/2-ethylhexyl acrylate (25.4% by mass)/styrene (8.6% by mass)/2-hydroxyethyl methacrylate (5.1% by mass)/acrylic acid (2.0% by mass) copolymer; and a latex of methyl methacrylate (64.0% by mass)/ styrene (9.0% by mass)/butyl acrylate (20.0% by mass)/2-hydroxyethyl methacrylate (5.0% by mass)/acrylic acid (2.0% by mass) copolymer. As the binder for the protective layer may be applicable the combination of polymer latices described in Japanese Patent Application No. 11-6872; the technique described in Japanese Patent Application No. 11-143058, column nos. 0021 to 0025; the technique described in Japanese Patent Application No. 11-6872, column nos. 0027 to 0028; and the technique described in Japanese Patent Application No. 10-199626, column nos. 0023 to 0041. The percentage of the polymer latex used in the protective layer is preferably 10% by mass or more and 90% by mass or less and more preferably 20% by mass or more and 80% by mass or less to the total amount of the binder used in the same.

The amount of all the binders (including water-soluble polymer and latex polymer) in the protective layer (per 1 layer) coated (per 1 m² of substrate) is preferably 0.3 to 5.0 g/m² and more preferably 0.3 to 2.0 g/m².

Preferably the preparation of the coating solution for the image forming layer used in this invention is carried out at 30° C. or more and 65° C. or less, more preferably at 35° C. or more and less than 60° C., and much more preferably at 35° C. or more and 55° C. or less. Preferably the temperature of the coating solution for the image forming layer immediately after the addition of a polymer latex is kept at 30° C. or more and 65° C. or less. And preferably a reducing agent and an organic silver salt are mixed into the coating solution before the addition of a polymer latex.

Preferably the organic-silver-salt-containing fluid or the coating solution for heat image forming layer is a thixotropic fluid. The thixotropic properties are the properties that allow the viscosity of a fluid to be decreased with the increasing shear rate. Measurement of viscosity in this invention may be made with any measuring device; however, it is preferably made with an RFS fluid spectrometer manufactured by Rheometrics Far East Ltd. at 25° C. The viscosity, at a shear rate of 0.1 S⁻¹, of the organic-silver-salt-containing fluid or the coating solution for heat image forming layer used in this invention is preferably 400 mPa·s or more and 100,000 mPa·s or less and more preferably 500 mPa·s or more and 20,000 mPa·s or less. The viscosity at a shear rate of 1000 S⁻¹ is preferably 1 mPa·s or more and 200 mPa·s or less and more preferably 5 mPa·s or more and 80 mpa·s or less.

There have been known various systems that develop thixotropic properties and such systems are described in A Series of Lectures, Rheology, (edited by High Polymer Publishing Association) and Muroi and Morino, High Polymer Latices (High Polymer Publishing Association). For fluid to develop thixotropic properties, it must contain a lot of solid fine particles. And to enhance the thixotropic properties of fluid, it is effective to add a linear polymer thickener to the fluid, to increase the aspect ratio of the anisotropic solid fine particles contained in the fluid, and to use an alkali thickening agent and a surfactant.

The heat development photographic emulsion used in this invention is applied to a substrate to form one or more layers. The photographic emulsion made up of a single layer needs to contain organic silver salt, silver halide, a developing agent and a binder, and in addition, desired additional ingredients such as toner, coating auxiliary and other assistants in one layer. The photographic emulsion made up of two layers needs to contain organic silver salt and silver halide in its first emulsion layer (usually the layer adjacent to the substrate) and some other ingredients in its second layer or in both the layers. However, it is also possible to form two layers on a substrate: one is a single emulsion layer that contains all the ingredients; and the other is a protective top coat. Multi-color photosensitive heat development photographic materials may be constructed so as to include the above described combination of two layers for each color or include a single layer that contains all the ingredients as described in U.S. Pat. No. 4,708,928. In multi-dye multi-color photosensitive heat development photographic materials, generally emulsion layers are kept separately from each other using a functional or non-functional barrier layer between the two adjacent photosensitive layers, as described in U.S. Pat. No. 4,460,681.

For the photosensitive layer used in this invention, various dyes and pigments (e.g. C.I. Pigment Blue 60, C.I. Pigment Blue 64, C.I. Pigment Blue 15:6) can be used from the point of view of improvement in color tone, prevention of the occurrence of interference fringes at the time of laser exposure and prevention of the irradiation. The use of these dyes and pigments is described in detail in WO 98/36322 and Japanese Patent Application Publication Nos. 10-268465 and 11-338098.

In the thermal-developable light-sensitive material used in this invention, an anti-halation backing can be provided on the side far away from a light source relative to the photosensitive layer.

Thermal-developable light-sensitive material s generally have not only photosensitive layers, but non-photosensitive layers. The non-photosensitive layers can be classified into 4 layers according to their arrangement: (1) protective layer provided on a photosensitive layer (on the side far away from the substrate), (2) intermediate layer provided between more than one photosensitive layers or between a photosensitive layer and a protective layer, (3) primer layer between a photosensitive layer and a substrate, and (4) back layer provided on the opposite side to a photosensitive layer. A filter layer is provided as a layer of (1) or (2) in a photosensitive material. An anti-halation backing is provided as a layer of (3) or (4) in a photosensitive material.

Anti-halation backings are described in Japanese Patent Application Publication No. 11-65021, column nos. 0123 to 0124 and Japanese Patent Application Publication Nos. 11-223898, 9-230531, 10-36695, 10-104779, 11-231457, 11-352625 and 11-352626.

An anti-halation backing contains an anti-halation dye having absorption at an exposure wavelength. When the exposure wavelength is in the infrared region, an infrared absorption dye can be used. In that case, a dye that does not have absorption in the visible range is preferably used.

When preventing the occurrence of halation using a dye having absorption in the visible range, it is preferable not to allow the color of the dye to remain after the formation of images, it is preferable to use a device which decolors the dye using the heat of the heat development, and it is particularly preferable to add a heat-sensitive fugitive dye and a basic precursor to the non-photosensitive layer so that they function as an anti-halation backing. The techniques for this are described in Japanese Patent Application Publication No. 11-231457 etc.

The amount of the decoloring dye added is determined depending on its application. Generally, a decoloring dye is used in amounts that allow the optical density (absorbance), when measuring at an intended wavelength, to exceed 0.1. Preferably the optical density is 0.2 to 2. The amount of the dye used to achieve such optical density is usually about 0.001 to 1 g/m².

Decoloring such a dye in this manner makes it possible to decrease the optical density after heat development to 0.1 or less. Two or more kinds of decoloring dyes may be used together in heat-decoloring-type recording materials or thermal-developable light-sensitive material s. Likewise, two or more kinds of basic precursors may also be used together.

In the heat decoloring process which uses a decoloring dye and a basic precursor, it is preferable from the viewpoint of heat decoloring properties etc. to use a substance (e.g. diphenyl sulfone, 4-chlorophenyl(phenyl) sulfone) that decreases the melting point of the precursor by 3° C. (deg) or more when mixed with it.

In this invention, a coloring agent having its absorption maxima at wavelengths of 300 to 450 nm can be added so as to improve silver tone and changes in images with time. Such coloring agents are described in Japanese Patent Application Publication Nos. 62-210458, 63-104046, 63-103235, 63-208846, 63-306436, 63-314535, 01-61745, and Japanese Patent Application No. 11-276751.

Such coloring agents are usually added in amounts in the range of 0.1 mg/m² to 1 g/m² and preferably added to a back layer provided on the opposite side to the photosensitive layer.

Preferably the heat developing photosensitive material used in this invention is the so-called one side photosensitive material having at least one photosensitive layer, which contains a silver halide emulsion, on one side of the substrate and a back layer on the other side of the substrate.

In this invention, preferably a matting agent is added to improve the conveying properties of the photosensitive material. Such matting agents are described in Japanese Patent Application Publication No. 11-65021, column nos. 0126 to 0127. The amount of the matting agent added per 1 m² of photosensitive material is preferably 1 to 400 mg/m² and more preferably 5 to 300 mg/m².

The matte degree of the emulsion surface is not particularly limited as long as stardust defects are not caused. Preferably the surface has a Bekk smoothness of 30 seconds or more and 2000 seconds or less and particularly preferably 40 seconds or more and 1500 seconds or less. The Bekk smoothness is easily obtained in accordance with JIS P8119 “Method for Testing Paper and Paper Board Smoothness with Bekk Tester” and TAPPI standard method T479.

In this invention, the matte degree of the back layer, in terms of Bekk smoothness, is preferably 1200 seconds or less and 10 seconds or more, and more preferably 800 seconds or less and 20 seconds or more, and particularly preferably 500 seconds or less and 40 seconds or more.

In this invention, preferably a matting agent is contained in the outermost surface layer of the photosensitive material or the layer that functions as the outermost surface layer of the photosensitive material or in the layer close to the outermost surface or in the layer that functions as a protective layer.

The back layer applicable to this invention is described in Japanese Patent Application Publication No. 11-65021, column nos. 0128 to 0130.

Preferably the thermal-developable light-sensitive material used in this invention has a film surface pH of 6.0 or less and more preferably 5.5 or less. The minimum value of pH is not limited to any specific one, but it is about 3. It is preferable from the point of view of decreasing the film surface pH to use an organic acid such as phthalic acid or a nonvolatile acid such as sulfuric acid or volatile base such as ammonia to adjust the film surface pH. Ammonia is particularly preferable in terms of achieving a low film surface pH because it easily volatilizes and can be removed during the coating process or before the heat development process. The method of measuring the film surface pH is described in Japanese Patent Application No. 11-87297, column no. 0123.

A hardener may be used for the layers, such as photosensitive layer, protective layer and back layer, of the thermal-developable light-sensitive material used in this invention. Examples of such hardeners are described in T. H. James, THE THEORY OF THE PHOTOGRAPHIC PROCESS FOURTH EDITION (Macmillan Publishing Co., Inc., 1977). 77-78. Polyvalent metal ions described in the above book, p. 78, polyisocyanates described in U.S. Pat. No. 4,281,060 and Japanese Patent Application Publication No. 6-208193, epoxy compounds described in U.S. Pat. No. 4,791,042 and vinylsulfone compounds described in Japanese Patent Application Publication No. 62-89048 are preferably used.

A hardener is added in the form of a solution. And the timing of the addition of the solution of a hardener to the coating solution for the protective layer is from the time point of 180 minutes to immediately before the coating of the coating solution and preferably from the time point of 60 minutes to 10 seconds before the coating of the coating solution. The mixing process and conditions are not limited to any specific process or conditions as long as the effects of this invention are fully achieved. Concrete examples of mixing processes are a process in which the mixing is carried out in a tank which is designed so that the average residence time of the mixture calculated using the flow rate of the silver halide added and the amount of the coating solution fed to the coater becomes a desired time; and a process using a static mixer which is described in N. Harnby, M. F. Edwards and A. W. Nienow, Liquid Mixing Technology (The Nikkan Kogyo Simbun Ltd., translated by Koji Takahashi, 1989), chapter 8.

Surfactants applicable to this invention are described in Japanese Patent Application Publication No. 11-65021, column no. 0132; solvents in the same specification as above, column no. 0133; substrates in the same specification, column no. 0134; anti-static or conductive layers in the same specification, column no. 0135; methods for obtaining color images in the same specification, column no. 0136; and sliding agents in Japanese Patent Application Publication No. 11-84573, column nos. 0061 to 0064 and Japanese Patent Application No. 11-106881, column nos. 0049 to 0062.

For the transparent substrate, polyester, particularly polyethylene terephthalate is preferably used which has been heat treated at the temperature range of 130 to 185° C., so that the internal strain remaining in the film can be relieved during the biaxially orientating operation and the strain caused by the heat shrinkage during the heat development treatment can be eliminated. In medical thermal-developable light-sensitive material s, the transparent substrate may be colored with a blue dye (e.g. dye-1 described in the examples, Japanese Patent Application Publication No. 8-240877) or may not be colored. To the substrate is preferably applied a priming technique using, for example, water-soluble polyester described in Japanese Patent Application Publication No. 11-84574, styrene-butadiene copolymer described in Japanese Patent Application Publication No. 10-186565, or vinylidene chloride copolymer described in Japanese Patent Application No. 11-106881, column nos. 0063 to 0080. Techniques for anti-static layers or priming coat described in Japanese Patent Application Publication Nos. 56-143430, 56-143431, 58-62646, 56-120519, Japanese Patent Application Publication No. 11-84573, column nos. 0040 to 0051, U.S. Pat. No. 5,575,957, and Japanese Patent Application Publication No. 11-223898, column nos. 0078 to 0084 are also applicable to the substrate.

Preferably the thermal-developable light-sensitive material used is of mono-sheet type (a type that allows images to be formed on the thermal-developable light-sensitive material without using other sheets such as image receiving materials).

The thermal-developable light-sensitive material may contain additives such as antioxidant, stabilizer, plasticizer, ultraviolet absorber and coating auxiliary. Such additives are added to either the photosensitive layer or the non-photosensitive layer. For the additives, WO 98/36322, European Patent No. 803764A1 and Japanese Patent Application Publication Nos. 10-186567 and 10-18568 can be consulted.

Any method may be employed for coating the thermal-developable light-sensitive material used in this invention. Concrete examples of coating methods are extrusion coating, slide coating, curtain coating, dip coating, knife coating and flow coating. Or various coating operations which include extrusion coating using a hopper of a type described in U.S. Pat. No. 2,681,294 may also be employed. Preferably the extrusion coating or slide coating described in Stephen F. Kistler and Petert M. Schweizer, LIQUID FILM COATING (CHAPMAN & HALL, 1997), 399-536 is employed and particularly preferably the slide coating is employed. Examples of the shapes of the slide coater used in the slide coating are described in the same book as above, p. 427, FIG. 11b.1. Two or more layers can also be applied at a time, as the need arises, in accordance with the method described in the above book, pp. 399-536, or any one of the methods described in U.S. Pat. No. 2,761,791 and G.B. Patent No. 837,095.

Techniques that can be used in the thermal-developable light-sensitive material used in this invention include, for example, those described in European Patent Nos. 803764A1 and 883022A1, WO 98/36322, and Japanese Patent Application Publication Nos. 56-62648, 58-62644, 9-281637, 9-297367, 9-304869, 9-311405, 9-329865, 10-10669, 10-62899, 10-69023, 10-186568, 10-90823, 10-171063, 10-186565, 10-186567, 10-186569, 10-186570, 10-186571, 10-186572, 10-197974, 10-197982, 10-197983, 10-197985, 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536, 11-133537, 11-133538, 11-133539, 11-133542, 11-133543 and 11-223898.

The thermal-developable light-sensitive material used in this invention may be developed by any method. However, the development is usually carried out while increasing the temperature of the thermal-developable light-sensitive material having been exposed imagewise. Preferably the development temperature is 80 to 250° C. and more preferably 100 to 140° C. The development time is preferably 1 to 180 seconds, more preferably 10 to 90 seconds and much more preferably 10 to 40 seconds.

As a heat development system, a plate heater type of system is preferably employed. A preferred plate heat type of heat developing system is described in Japanese Patent Application Publication No. 11-133572. The system is a heat development system in which a thermal-developable light-sensitive material with a latent image formed thereon is brought in contact with a heating device at the heat development portion to produce a visible image, the system being characterized in that the heating device is made up of a plate heater, a plurality of press rollers are arranged along one side of the plate heater so that they are opposite to the side, and the thermal-developable light-sensitive material is passed between the press rollers and the plate heater to be heat developed. Preferably, the plate heater is divided into 2 to 6 columns and the temperature of each tip portion is decreased by about 1 to 10° C. This type of system is also described in Japanese Patent Application Publication No. 54-30032. The system enables removing the moisture or organic solvent contained in the thermal-developable light-sensitive material to the outside of the material system, and besides, retarding the changes in shape of the substrate for the thermal-developable light-sensitive material caused by rapid heating of the thermal-developable light-sensitive material

Any method may be employed to expose the thermal-developable light-sensitive material used in this invention to light. However, laser light is preferably used as an exposure source. Laser light used in this invention is preferably light of gas laser (Ar⁺, He-Ne), YAG laser, dye laser and semiconductor laser. A semiconductor laser can be used together with a second harmonic generating device. A preferred laser is a red to infrared emitting gas or semiconductor laser.

One example of medical laser imagers that include an exposure portion and a heat development portion is Fuji Medical Dry Laser Imager FM-DPL. The technology of FM-DPL is described in Fuji Medical Review No. 8, pp. 39-55, and it goes without saying that the technology is applicable as a laser imager for the thermal-developable light-sensitive material used in this invention. Further, the thermal-developable light-sensitive material used in this invention is also applicable as a thermal-developable light-sensitive material for a laser imager in “AD network”, which Fuji Medical System has proposed as a network system conforming to the DICOM standards.

The thermal-developable light-sensitive material used in this invention forms black-and-white pictures of silver image and is preferably used as a thermal-developable light-sensitive material for use in medical diagnosis, industrial photographs, printing and COM.

(Formation of PET substrate)

PET having an intrinsic viscosity IV of 0.66 (measured in phenol/tetrachloroethane=6/4 (weight ratio) at 25° C.) was obtained by conventional procedure using terephthalic acid and ethylene glycol. The PET was pelletized, dried for 4 hours at 130° C., melted at 300° C., extruded from a T-dye and quenched to form an unorientated film whose thickness after thermal fixation is 175 μm.

The film was stretched across its length with rolls different in peripheral velocity to give a 3.3-fold length and then stretched across its width with a tenter to give a 4.5-fold width. The temperatures at the time of stretching were 110° C. and 130° C., respectively. After this, the film was thermally fixed at 240° C. for 20 seconds and then relaxed across its width by 4% at the same temperature. Then the chuck portions of the tenter were slit, and the film was knurled at its both ends, wound up at 4 kg/cm² to obtain a roll of substrate 175 μm thick.

(Corona Surface Treatment)

Both sides of the substrate were subjected to corona surface treatment at room temperature at 20 m/min with a solid state corona treatment system, Model 6KVA, manufactured by Pillar Technologies. The readings of current/voltage readers showed that the substrate was subjected to treatment of 0.375 kV·A·min/m². The treatment frequency was 9.6 kHz and the gap clearance between the electrode and the dielectric roll was 1.6 mm.

### (1) Preparation of Coating Solution for Primary Coat

Formulation 1 (For Primary Coat on the Photosensitive Layer Side)

Pethresin A-515GB (30% by mass solution) by Takamatsu Yushi Co., Ltd.: 234 g, 10% by mass solution of polyethylene glycol monononyl phenyl ether (average number of ethylene oxides=8.5): 21.5 g, MP-1000 (polymer fine particles, average particle size 0.4 μm) by Soken Chemical & Engineering Co., Ltd.: 0.91 g, distilled water: 744 ml

Formulation 2 (For First Layer on the Back Side)

butadiene-styrene copolymer latex (solid content 40% by mass, butadiene/styrene weight ratio=32/68): 158 g, 8% by mass aqueous solution of sodium salt of 2,4-dichloro-6-hydroxy-S-triazine: 20 g, 1% by mass aqueous solution of sodium laurylbenzene sulfonate: 10 ml, distilled water: 854 ml

Formulation 3 (For Second Layer on the Back Side)

SnO₂/SbO (9/1 weight ratio, average particle size 0.038 μm, 17% by mass dispersion): 84 g, gelatin (10% aqueous solution): 89.2 g, Metolose TC-5 (2% aqueous solution) by Shin-Etsu Chemical Co., Ltd.: 8.6 g, MP-1000 (polymer fine particles) by Soken Chemical & Engineering Co., Ltd.: 0.01 g, 1% by mass aqueous solution of sodium dodecylbenzene sulfonate: 10 ml, NaOH (1%): 6 ml, Proxel (by ICI): 1 ml, distilled water: 805 ml

(Formation of Primed Substrate)

Both sides of the above described biaxially orientated polyethylene terephthalate substrate 175 μm thick were subjected to the above described corona discharge treatment, one side (photosensitive layer side) was coated with the coating solution for primary coat of formulation 1 using a wire bar so that the amount of the wet coating became 6.6 ml/m² (per one side) and dried for 5 minutes at 180° C., the other side (back side) was coated with the coating solution for primary coat of formulation 2 using a wire bar so that the amount of the wet coating became 5.7 ml/m² and dried for 5 minutes at 180° C., and then the other back side was further coated with the coating solution for primary coat of formulation 3 using a wire bar so that the amount of the wet coating became 7.7 ml/m² and dried for 6 minutes at 180° C., to form a primed substrate.

(Preparation of Coating Solution for Back side)

(Preparation of Dispersion (a) of Basic Precursor Solid Fine Particles)

64 g of basic precursor compound 11, 28 g of diphenyl sulfone and 10 g of DEMOL, surfactant, by Kao Corporation were mixed with 220 ml of distilled water and the mixed solution was bead dispersed using a sand mill (¼ Gallon Sand Grinder Mill, by IMEX) to obtain a dispersion (a) of basic precursor compound solid fine particles having an average particle diameter of 0.2 μm.

(Preparation of Dispersion of Dye Solid Fine Particles)

9.6 g of cyanine dye compound 13 and 5.8 g of sodium p-dodecylbenzene sulfonate were mixed with 305 ml of distilled water and the mixed solution was bead dispersed using a sand mill (¼ Gallon Sand Grinder Mill, by IMEX) to obtain a dispersion of dye solid fine particles having an average particle diameter of 0.2 μm.

(Preparation of Coating Solution for Anti-Halation Backing)

17 g of gelatin, 9.6 g of polyacrylamide, 70 g of the above described dispersion (a) of basic precursor solid fine particles, 56 g of the above described dispersion of dye solid fine particles, 1.5 g of polymethyl methacrylate fine particles (average particle size 6.5 μm), 0.03 g of benzoisothiazoline, 2.2 g of sodium polyethylene sulfonate, 0.2 g of blue dye compound 14 and 3.9 g of yellow dye compound 15 were mixed with 844 ml of water to prepare a coating solution for anti-halation backing.

(Preparation of Coating Solution for Back Side Protective Layer)

In a contriner warmed to 40° C., 50 g of gelatin, 0.2 g of sodium polystyrene sulfonate, 2.4 g of N,N-ethylene bis(vinylsulfoneacetoamide), 1 g of sodium t-octylphenoxyethoxyethane sulfonate, 30 mg of benzoisothiazoline, 37 mg of potassium salt of N-perfluorooctylsulfonyl-N-propylalanine, 0.15 g of polyethylene glycol mono(N-perfluorooctylsulfonyl-N-propyl-2-aminoethyl) ether [ethylene oxide average polymerization degree 15], 32 mg of C₈F₁₇SO₃K, 64 mg of C₈F₁₇SO₂N(C₃H₇) (CH₂CH₂O)₄(CH₂)₄SO₃Na, 8.8 g of acrylic acid/ethyl acrylate copolymer (copolymer weight ratio 5/95), 0.6 g of Aerosol TO (American Cyanamid), 1.8 g of liquid paraffin emulsion as liquid paraffin were mixed with 950 ml of water to prepare a coating solution for back side protective layer.

<<Preparation of Silver Halide Emulsion 1>>

A solution, which was prepared by adding 3.1 ml of 1% by mass potassium bromide, 3.5 ml of 1 mol/L sulfuric acid and 31.7 g of phthalated gelatin to 1421 ml of distilled water, was kept at 34° C. in a titanium-coated stainless steel reactor while being stirred, and a solution A, which was prepared by diluting 22.22 g of silver nitrate with distilled water to 95.4 ml, and a solution B, which was prepared by diluting 15.9 g of potassium bromide with distilled water to 97.4 ml, were entirely added to the solution in the reaction pot at a fixed flow rate over 45 seconds. Then, 10 ml of 3.5% by mass aqueous solution of hydrogen peroxide and 10.8 ml of 10% by mass aqueous solution of benzimidazol were added in this order. Further, a solution C, which was prepared by diluting 51.86 g of silver nitrate with distilled water to 317.5 ml, was entirely added at a fixed flow rate over 20 minutes and a solution D, which was prepared by diluting 45.8 g of potassium bromide with distilled water to 400 ml, was added by controlled double jet process keeping its pAg at 8.1. Ten minutes after starting the addition of solutions C and D, potassium salt of iridium(III) hexachloride was added at a time so that the amount of potassium salt was 1×10⁻⁴ mol per 1 mol of silver. And five seconds after completing the addition of solution C, an aqueous solution of potassium iron(II) hexacyanide was added at a time so that the amount of potassium salt was 3×10⁻⁴ mol per 1 mol of silver. The pH of the solution was adjusted to 3.8 with 0.5 mol/L sulfuric acid, stirring was stopped, and the steps of settling/desalting/rinsing were performed. The pH of the resultant matter was adjusted to 5.9 with 1 mol/L sodium hydroxide to yield a dispersion of silver halide with a pAg of 8.0

The above dispersion of silver halide was kept at 38° C. while being stirred. Then 5 ml of 0.34% by mass methanol solution of 1,2-benzoisothiazoline-3-one was added to the dispersion, 40 minutes after this, a methanol solution of spectral sensitizing dye A was added so that the amount of sensitizing dye A was 1×10⁻³ mol per 1 mol of silver, and 1 minute after the addition of the sensitizing dye, the temperature of the dispersion was increased to 47° C. Twenty minutes after increasing the temperature, a methanol solution of sodium benzenethiosulfonate was added so that the amount of sodium benzenethiosulfonate was 7.6×10⁻⁵ mol per 1 mol of silver, and 5 minutes after this, a methanol solution of tellurium sensitizing agent B was added so that the amount of the sensitizing agent B was 1.9×10⁻⁴ mol per 1 mol of silver, and then the dispersion was matured for 91 minutes. Then 1.3 ml of 0.8% by mass methanol solution of N,N′-dihydroxy-N″-diethyl melamine was added to the dispersion, and 4 minutes after this addition, a methanol solution of 5-methyl-2-mercaptobenzimidazole and a methanol solution of 1-phenyl-2-heptyl-5-mercapto-1,3,4-triazole were added so that the amount of 5-methyl-2-mercaptobenzimidazole and the amount of 1-phenyl-2-heptyl-5-mercapto-1,3,4-triazole were 3.7×10⁻³ mol per 1 mol of silver and 4.9×10⁻³ mol per 1 mol of silver, respectively, to prepare silver halide emulsion 1.

The particles contained in the prepared silver halide emulsion were pure silver bromide particles having an average sphere-equivalent diameter of 0.046 μm and a coefficient of variation in sphere-equivalent diameter of 20%. The particle size etc. was obtained by averaging 1000 determinations made for 1000 particles using an electron microscope. The percentage of the plane {100} of the particle was 80% in accordance with Kubelka-Munk method.

<<Preparation of Silver Halide Emulsion 2>>

Silver halide emulsion 2 was prepared in the same manner as silver halide emulsion 1 except that the solution temperature at the time of particle formation was changed from 34° C. to 49° C., solution C was added over 30 minutes, and potassium iron(II) hexacyanide was eliminated. The steps of settling/desalting/rinsing/dispersing were performed in the same manner as silver halide emulsion 1. Silver halide emulsion 2 was obtained by adding spectral sensitizing agent A, chemical sensitizing agent B, and 1-phenyl-2-heptyl-5-mercapto-1,3,4-triazole in the same manner as emulsion 1 except that the amount of spectral sensitizing dye A added was changed to 7.5×10⁻⁴ mol per 1 mol of silver, the amount of tellurium sensitizing agent B added was changed to 1.1×10⁻⁴ mol per 1 mol of silver, and the amount of 1-phenyl-2-heptyl-5-mercapto-1,3,4-triazole added were changed to 3.3×10⁻³ mol per 1 mol of silver. The particles contained in silver halide emulsion 2 were pure silver bromide cubic particles having an average sphere-equivalent diameter of 0.080 μm and a coefficient of variation in sphere-equivalent diameter of 20%.

<<Preparation of Silver Halide Emulsion 3>>

Silver halide emulsion 3 was prepared in the same manner as silver halide emulsion 1 except that the solution temperature at the time of particle formation was changed from 34° C. to 27° C. The steps of settling/desalting/rinsing/dispersing were performed in the same manner as silver halide emulsion 1. Silver halide emulsion 3 was obtained in the same manner as silver halide emulsion 1 except that the amount of the dispersion of solid spectral sensitizing dye A (aqueous solution of gelatin) added was changed to 6×10⁻³ mol per 1 mol of silver and the amount of tellurium sensitizing agent B added was changed to 5.2×10⁻⁴ mol per 1 mol of silver. The particles contained in silver halide emulsion 3 were pure silver bromide cubic particles having an average sphere-equivalent diameter of 0.038 μm and a coefficient of variation in sphere-equivalent diameter of 20%.

<<Preparation of Mixed Emulsion A for Coating Solution>>

70% by mass of silver halide emulsion 1, 15% by mass of silver halide emulsion 2 and 15% by mass of silver halide emulsion 3 were dissolved and 1% by mass aqueous solution of benzothiazolium iodide was added so that the amount of benzothiazolium iodide added was 7×10⁻³ mol per 1 mol of silver.

<<Preparation of Scaly Silver Salt of Fatty Acid>>

87.6 kg of behenic acid manufactured by Henkel Corporation (product name: Edenor C22-85R), 423 L of distilled water, 49.2 L of aqueous solution of 5N-NaOH and 120 L of tert-butanol were mixed and allowed to react while stirred at 75° C. for 1 hour to obtain a solution of sodium behenate. 206.2 L of aqueous solution of 40.4 kg of silver nitrate (pH 4.0) was prepared separately and kept at 10° C. 635 L of distilled water and 30 L of tert-butanol were put into a reactor and kept at 30° C., and the whole amount of the above sodium behenate solution and the whole amount of the above silver nitrate aqueous solution were added to the reactor at a fixed flow rate over 62 minutes 10 seconds and over 60 minutes, respectively, while stirring the mixture. In this operation, the above two solutions were added so that for 7 minutes and 20 seconds after starting the addition of the silver nitrate aqueous solution, the silver nitrate aqueous solution alone was added and for 9 minutes and 30 seconds after completing the addition of the silver nitrate aqueous solution, the sodium behenate solution alone was added. And the temperature within the reactor was kept at 30° C. and the external temperature was controlled so as to keep the solution temperature constant. The piping for the addition system of the sodium behenate solution was thermally insulated by steam tracing and the steam opening was controlled so as to keep the solution temperature at the outlet at the tip of the addition nozzle at 75° C. The piping for the addition system of the silver nitrate aqueous solution was thermally insulated by circulating cold water outside the double piping. The position from which the sodium behenate solution was added and the position from which the silver nitrate aqueous solution was added were arranged symmetrically about the stirring rod and controlled to be sufficiently high not to come in contact with the reaction solution.

After completing the addition of the sodium behenate solution, the reaction solution was allowed to stand for 20 minutes while stirred at the same temperature and cooled to 25° C. After that, the solid content of the reaction solution was separated by centrifugation and rinsed until the conductivity of the filtrate became 100 μS/cm. Thus a silver salt of fatty acid was obtained. The resultant solid content was not dried and stored as a wet cake.

The form of the obtained silver behenate particles was evaluated by an electron microscopy. The electron micrographs showed that the silver behenate particles were scaly crystals having a=0.14 μm, b=0.4 μm, c=0.6 μm, in average, average aspect ratio was 5.2, average sphere-equivalent diameter was 0.52 μm, and coefficient of variation in sphere-equivalent diameter was 15% (a, b and c are specified in this specification).

7.4 g of polyvinyl alcohol (trade name: PVA-217) and water were added to the wet cake equivalent to 100 g of dried solid content to yield a solution weighing 385 g, and the solution was subjected to pre-dispersion in a homomixer.

Then the stock solution having been subjected to pre-dispersion was treated three times in a disperser (trade name: Microfluidizer M-110S-EH, by Microfluidex international Corporation, using a G10Z interaction chamber) with its pressure adjusted to 1750 kg/cm² to yield a dispersion of silver behenate. Cooling operation was carried out with coiled heat exchangers provided in front of and behind the interaction chamber and the dispersion temperature was set for 18° C. by controlling the coolant temperature.

<<Preparation of 25% by Mass Dispersion of Reducing Agent>>

10 kg of 1,1-bis(2-hydroxy-3,5-dimethylphenyl)-3,5,5-trimethyl hexane and 10 kg of 20% by mass aqueous solution of denaturated polyvinyl alcohol (by Kuraray Co., Ltd., POVAl MP 203) were fully mixed with 16 kg of water to yield a slurry. The slurry was pumped with a diaphragm pump into a horizontal sand mill (UVM-2, by IMEX) packed with zirconia beads having an average diameter of 0.5 mm and dispersed for 3 hours and 30 minutes. Then 0.2 g of sodium salt of benzoisothiazolinone and water were added to the dispersion to prepare a dispersion of a reducing agent so that the concentration of the reducing agent was 25% by mass. The reducing agent particles contained in the resultant dispersion of the reducing agent had a median diameter of 0.42 μm and a maximum particle diameter of 2.0 μm or less. The dispersion of the reducing agent was passed through a 10.0-μm propylene filter to remove foreign matter such as dust and stored.

<<Preparation of 10% by Mass Dispersion of Mercapto Compound>>

5 kg of 1-phenyl-2-heptyl-5-mercapto-1,3,4-triazole and 5 kg of 20% by mass aqueous solution of denaturated polyvinyl alcohol (by Kuraray Co., Ltd., POVAl MP 203) were fully mixed with 8.3 kg of water to yield a slurry. The slurry was pumped with a diaphragm pump into a horizontal sand mill (UVM-2, by IMEX) packed with zirconia beads having an average diameter of 0.5 mm and dispersed for 6 hours. Then water was added to the dispersion to prepare a dispersion of a mercapto compound so that the concentration of the mercapto compound was 10% by mass. The mercapto compound particles contained in the resultant dispersion of the mercapto compound had a median diameter of 0.40 μm and a maximum particle diameter of 2.0 μm or less. The dispersion of the mercapto compound was passed through a 10.0-μm propylene filter to remove foreign matter such as dust and stored. The dispersion was also passed through a 10-μm propylene filter immediately before the use.

<<Preparation of 20% by Mass Dispersion—1 of Organic Polyhalogen Compound>>

5 kg of tribromomethylnaphthylsulfone and 2.5 kg of 20% by mass aqueous solution of denaturated polyvinyl alcohol (by Kuraray Co., Ltd., POVAl MP 203), 213 g of 20% by mass aqueous solution of sodium triisopropylnaphthalenesulfonate were fully mixed with 10 kg of water to yield a slurry. The slurry was pumped with a diaphragm pump into a horizontal sand mill (UVM-2, by IMEX) packed with zirconia beads having an average diameter of 0.5 mm and dispersed for 5 hours. Then 0.2 g of sodium salt of benzoisothiazolinone and water were added to the dispersion to prepare a dispersion of the organic polyhalogen compound so that the concentration of the organic polyhalogen compound was 20% by mass. The organic polyhalogen compound particles contained in the resultant dispersion of the polyhalogen compound had a median diameter of 0.36 μm and a maximum particle diameter of 2.0 μm or less. The dispersion of the organic polyhalogen compound was passed through a 3.0-μm propylene filter to remove foreign matter such as dust and stored.

<<Preparation of 25% by Mass Dispersion—2 of Organic Polyhalogen Compound>>

An organic poly halogen compound was dispersed in the same manner as the 20% by mass dispersion—1 of organic polyhalogen compound except that 5 kg of tribromomethyl(4-(2,4,6-trimethylphenylsulfonyl)phenyl)sulfone was used instead of 5 kg of tribromomethylnaphthylsulfone, distilled so that the concentration of the organic polyhalogen compound was 25% by mass and filtrated. The organic polyhalogen compound particles contained in the resultant dispersion of the organic polyhalogen compound had a median diameter of 0.38 μm and a maximum particle diameter of 2.0 μm or less. The dispersion of the organic polyhalogen compound was passed through a 3.0-μm propylene filter to remove foreign matter such as dust and stored.

<<Preparation of 30% by Mass Dispersion—3 of Organic Polyhalogen Compound>>

An organic poly halogen compound was dispersed in the same manner as the 20% by mass dispersion—1 of organic polyhalogen compound except that 5 kg of tribromomethylphenylsulfone was used instead of 5 kg of tribromomethylnaphthylsulfone, and 20% by mass aqueous solution of MP203 was used in an amount of 5 kg instead of 2.5 kg, distilled so that the concentration of the organic polyhalogen compound was 30% by mass and filtrated. The organic polyhalogen compound particles contained in the resultant dispersion of the organic polyhalogen compound had a median diameter of 0.41 μm and a maximum particle diameter of 2.0 μm or less. The dispersion of the organic polyhalogen compound was passed through a 3.0-μm propylene filter to remove foreign matter such as dust and stored. The dispersion was kept at 10° C. or less after the storage and before the use.

<<Preparation of 5% by Mass Solution of Phthalazine Compound>>

8 kg of denaturated polyvinyl alcohol MP 203 by Kuraray Co., Ltd. was dissolved in 174.57 kg of water, and then 3.15 kg of 20% by mass aqueous solution of sodium triisopropylnaphthalenesulfonic acid and 14.28 kg of 70% by mass aqueous solution of 6-isopropylphthalazine were added to prepare a 5% by mass solution of 6-isopropylphthalazine.

<<Preparation of 20% by Mass Dispersion of Pigment>>

64 g of C.I. Pigment Blue 60 and 6.4 g of DEMOL N by Kao Corporation were fully mixed with 250 g of water to yield a slurry. 800 g of zirconia beads having an average diameter of 0.5 mm was prepared and put together with the slurry into a vessel, and dispersed with a disperser (¼ G sand grinder mill: IMEX) for 25 hours to obtain a dispersion of the pigment. The pigment particles contained in the resultant dispersion of the pigment had an average particle diameter of 0.21 μm.

<<Preparation of 40% by Mass SBR Latex>>

SBR latex having been purified by ultrafiltration was obtained as follows.

A 10-fold dilution of the SBR latex shown below with distilled water was purified with UF-purification module FS03-FC-FUY03A1 (Daicen Membrane System Co., Ltd.) so that the dilution had an ionic conductivity of 1.5 mS/cm, and then Sandet-BL by Sanyo Chemical Industries, Ltd. was added so that its concentration became 0.22% by mass. Further, NaOH and NH₄OH were added in amounts that allowed the relation Na⁺ion: NH₄⁺ion=1:2.3 (molar ratio) to hold and the pH to be 8.4. The concentration of the latex at this point was 40% by mass. (SBR latex: a latex of -St(68)-Bu(29)-AA(3)-)

<<Preparation of Coating Solution for Emulsion Layer (Photosensitive Layer)>>

First, 5.5 kg of 20% by mass aqueous dispersion of a pigment obtained above was fed to the mixing vessel of an adjusting/deaerating apparatus, and then 515 kg of dispersion of a silver salt of organic acid was added while setting the outlet position of the feeding pipe in the mixing vessel about 3 cm below the level of the pigment dispersion having been fed. Then, 25 kg of 20% by mass polyvinyl alcohol PVA-205 (by Kuraray Co., Ltd.), 125 kg of 25% by mass reducing agent dispersion described above, 81.5 kg, in total, of dispersions -1, -2 and -3 of organic polyhalogen compounds (weight ratio 5:1:3), 31 kg of 10% dispersion of mercapto compound, 530 kg of 40% by mass SBR latex having undergone purification by ultrafiltration (UF) and pH adjustment, and 90 L of 5% by mass solution of phthalazine compound were added to prepare mother liquor for the coating solution. In this operation, the outlet position of the feeding pipe for the coating solution constituent of 20% by mass polyvinyl alcohol PVA-205 (by Kuraray Co., Ltd.) was slid so that it was positioned about 20 cm below the level of the solution. The mixing vessel used was 160 cm in inside diameter and the agitating element used was a turbine impeller 40 cm in diameter. The mixing vessel was equipped with a jacket and the temperature inside the tank was kept at 35° C. by circulating heat water. After all the coating solution constituent solutions were fed to the mixing vessel, the pressure inside the mixing vessel was reduced to 30 kPa, and agitation mixing and vacuum degassing were carried out for 180 minutes at a turbine impeller revolution of 100 r.p.m..

Then, 50 kg of mixed emulsion A of silver halide was fed and added from an addition line to an in-line mixing equipment via an inlet pipe, which was for feeding the mother liquor into the in-line mixing equipment, right in front of the mixing tank.

### EXAMPLES

Hereinbelow this invention will be described in detail taking several examples; however, it should be understood that the embodiments of this invention are not limited to these examples. In examples 1 and 9 experimental conditions will be described in detail, but in examples 2 to 8 and 10 to 12 and comparative examples 1 to 11 the description of the same experimental conditions as examples 1 and 9 will be omitted.

<Experiment 1>

Experiments were conducted as examples 1 to 7 to eliminate the coating non-uniformity on a web resulting from repeated deformation in cut edge by giving heat treatment to the web before coating operation and optimizing the factors of coating operation. Comparative experiments were also conducted as comparative examples 1 to 4.

[Evaluation of Quality of Web Surface and Coated Surface]

In each experiment evaluations were carried out of the quality of the web surface and the coated surface, and the results are summarized in Table 1 shown later. The quality of the web surface was evaluated visually and was classified into 2 grades of “no scratch observed and good” (B) and “scratches observed” (F). The quality of the coated surface was evaluated and classified into 3 grades of “no problem at all with the surface of coating film” (B), “coating non-uniformity observed but practically no problem” (C), “thick coating occurred at the selvage portion and problematic as a product” (F1) and “air non-uniformity occurred and problematic as a product” (F2).

### Example 1

Multilayer co-coating of more than one kind of coating solution, including the coating solution prepared in the above <<Preparation of Coating Solution for Emulsion Layer (Photosensitive Layer)>>, was performed with a slide bead coating apparatus at a coating rate of 120 m/min. The distance d between the lip 54 of the die and a web 10 was set for 220 μm. Three heating rollers were provided in the heating zone where heating air could be circulated. The heating roller temperature shown in Table 1 means the temperature of the most downstream heating roller; specifically, if the heating roller temperature is 60° C., the temperatures of the first, second and third heating rollers from the upstream downward are 30° C., 45° C. and 60° C., respectively. The draw rate of the web in the heating zone was set for +0.4% and the lapping angle of the web at the heating rollers were set for 180°. The web was fed into the cooling zone after passing through the heating zone. In the cooling zone, air at 30° C. was circulated. Cooling rollers were provided in the cooling zone and the temperature of the web having increased in the heating zone was decreased in this zone. Between the cooling zone and the coating apparatus a non-contacting far-infrared temperature sensor was provided to measure the temperature of the web before coating operation. The temperature value was fed back according to the target temperature before coating operation from the temperature sensor to a temperature controller to adjust the temperature of the cooling rollers. In this example, the temperature of the cooling rollers was controlled so that the temperature of the web before coating operation was 35° C. After giving leveling treatment to the surface of the web, the reduced pressure of the back surface was set for 490 Pa, and the coating of the above described coating solutions was performed to produce a film.

After drying the produced film, the presence or absence of coating non-uniformity was visually observed at the portion right in front of the web's joining portion where repeated deformation in cut edge existed before coating operation. The observation showed no coating non-uniformity existed (B). And no scratch existed on the web, either (B).

### Examples 2 to 6

The experimental conditions of examples 2 to 6 are summarized in Table 1. The heating roller temperature of 90° C. in Table 1 means the temperatures of the first, second and third heating rollers from the upstream downward are 65° C., 80° C. and 90° C., respectively. Experiments were conducted under the same conditions as example 1 except those shown in Table 1. The results are summarized in Table 1.

### Example 7

In the experiment in example 7, the web was not heated in the heating zone. The other experimental conditions were the same as those of example 1. The results are summarized in Table 1.

### Comparative Examples 1 to 4

The experimental conditions of comparative examples 1 to 4 are summarized in Table 1. The other experimental conditions were the same as those of example 1. The results are summarized in Table 1.

The results shown Table 1 indicate that a coating film with a good-quality coated surface is obtained by giving a web leveling treatment before coating the web with coating solutions. The results of example 7 show that leveling treatment does not necessarily require the step of heating the web.

<Experiment 2>

Experiments were conducted as examples 8 to 11 to retard the occurrence of coating non-uniformity due to the non-uniformity in electrification of the web surface. Comparative experiments were also conducted as comparative examples 5 and 6.

[Evaluation of Conveying Properties of Web and Quality of Coated Surface]

In each experiment evaluations were carried out of the conveying properties of the web and the quality of the coated surface, and the results are summarized in Table 2 shown later. The conveying properties of the web were evaluated and classified into 2 grades of “no problem” (B) and “problem occurred of the spline portion of web coming in contact with coating apparatus and broken” (F). The quality of the coated surface was evaluated and classified into 4 grades of “no problem at all with the surface of coating film” (A), “no problem with the surface of coating film” (B), “a little coating non-uniformity occurred on the surface of the coating film but the film was usable depending on the type of the product” (C), “non-uniformity of electrification non-uniformity pattern occurred and the film was not usable as a product” (F3) and “wood particle-like non-uniformity occurred and the film was not usable as a product” (F4).

### Example 8

Multilayer co-coating of more than one kind of coating solution, including the coating solution prepared in the above <<Preparation of Coating Solution for Emulsion Layer (Photosensitive Layer)>>, was performed with a slide bead coating apparatus at a coating rate of 120 m/min. Immediately before coating operation, the surface of the web to be coated with coating solutions was charged to 400±100 V with an electric charger to cause electrification non-uniformity on the web. The electrification was conducted on the surface to be coated by corona discharge through a 100 μm tungsten wire using a roller on which vinyl tape had been stuck at intervals of 10 mm. The coating rate U was 3 (m/s) and the distance between the lip and the web d was 180 μm (=1.8 10⁻⁴) under these conditions. In this case the shear rate (U/d) was 16700 (l/s) and the effective viscosity of the coating solution for the lowest layer was 15 mPa·s. The coating solution was applied while setting the web temperature for 35° C., the coating solution temperature for 36° C. and the reduced pressure of the back surface for 490 Pa. The conveying properties of the web and the coating non-uniformity of the coating film were visually observed. Under these conditions, the coating no-uiformity caused by electrification non-uniformity could be eliminated without causing a problem with the conveying properties of the web (B) and there was observed no problem with the quality of the coated surface (B).

### Examples 9 to 11

The experimental conditions of examples 9 to 11 are summarized in Table 2. The other experimental conditions were the same as those of example 8. The results are summarized in Table 2.

### Comparative Examples 5 and 6

The experimental conditions of comparative examples 5 and 6 are summarized in Table 2. The other experimental conditions were the same as those of example 8. The results are summarized in Table 2.

The results shown in Table 2 indicate that a good-quality coated surface is obtained when the effective viscosity of the coating solution for the lowest layer is in the range of 15 to 30 mPa·s (examples 8 to 11). The results also show that in example 9, where the effective viscosity of the coating solution for the lowest layer was 30 mPa·s, and in example 10, where the reduced pressure of the back surface was 686 Pa, coating films were formed in which the quality of the coated surface was completely satisfactory (A).

1. A coating method for coating a continuously running web with a coating solution fed through a die in the production process of a thermal-developable light-sensitive material, wherein the surface of the web is subjected to leveling treatment before the coating operation.

2. The coating method according to claim 1, wherein the leveling treatment comprises:
a heating step of heating the web; and
a cooling step of cooling the web.

3. The coating method according to claim 2, wherein the heating step comprises: at least one of
a step of heating the web with a heating roller in the temperature range of 50 to 125° C., and
a step of blowing air in the temperature range of 30 to 125° C. onto the web.

4. The coating method according to claim 2, wherein the cooling step is a step of cooling the web to 25 to 45° C. with a cooling roller.

5. The coating method according to claim 2, wherein the cooling step is a step of blowing air whose temperature is lower than that of the web.

6. The coating method according to claim 3, wherein the draw rate when the heating roller draws the web is set to fall in the range of +0.2 to +2.0%.

7. The coating method according to claim 2, wherein the temperature of the web before the coating operation is measured during the period of time after the cooling step and before the web is coated with the coating solution, and the temperatures of the web in the heating step and in the cooling step are controlled based on the measured temperature of the web.

8. The coating method according to claim 7, wherein the temperature of the web before the coating operation is in the range of 25 to 45° C.

9. The coating method according to claim 3, wherein a plurality of heating rollers are provided and the temperatures of the downstream heating rollers are set higher than temperatures of the upstream heating rollers.

10. The coating method according to claim 4, wherein a plurality of cooling rollers are provided and the temperatures of the downstream cooling rollers are set lower than temperatures of the upstream cooling rollers.

11. The coating method according to claim 2, wherein in the heating step, at least one of a heating roller and a conveying roller that allows the web to run is used and the lapping angle of the web passed around the roller is in the range of 30 to 240 degrees.

12. The coating method according to claim 1, wherein the coating method is a slide bead coating method in which the coating solution fed through the die is applied to a continuously running web through bead forming and the effective viscosity of the coating solution is 15 to 30 mPa·s, where the effective viscosity is defined as the viscosity at a shear rate of U/d, the coating rate of the coating solution is represented by U (m/s) and the distance between the lip of the die and the web by d (m).

13. The coating method according to claim 12, wherein the reduced pressure at the back surface of the bead is in the range of 300 to 1000 Pa, the distance d between the lip of the die and the web is in the range of 140 to 300 μm and the temperature of the coating solution is in the range of 34 to 42° C.

14. A coating line that comprises a coating apparatus for coating a continuously running web with a coating solution fed through a die, wherein a leveling apparatus for leveling the surface of the web is provided upstream relative to the coating apparatus.
